(19) United States
(12) Patent Application Publication
(10) Pub. No.: US 2024/0112167 A1
(43) Pub. Date: Apr. 4, 2024

(54) SYSTEMS AND METHODS FOR PROCESSING MICROPAYMENTS

(71) Applicant: AMPACASH CORPORATION, Marlboro, NJ (US)

(72) Inventor: Chijioke Chukwuemeka Uzo, Marlboro, NJ (US)

(21) Appl. No.: 18/275,688

(22) PCT Filed: Feb. 8, 2022
(86) PCT No.: PCT/US22/15656

§ 371 Date: Aug. 3, 2023

Related U.S. Application Data
(60) Provisional application No. 63/147,185, filed on Feb. 8, 2021.

(30) Foreign Application Priority Data
Feb. 8, 2022 (WO) PCT/US22/15656

(51) Int. Cl. G06Q 20/22; G06Q 20/32; G06Q 20/38; G06Q 20/40

(52) U.S. Cl. CPC G06Q 20/29; G06Q 20/322; G06Q 20/385; G06Q 20/4012

(57) ABSTRACT

A system and method for processing micropayments includes a user device of a user with a processor, memory and a phone number, a network, a payment processor, and a client application. The payment processor is in communication with the user device over the network. The client application is configured to process payments from the user over the network. Wherein, the client application is configured to create a mobile account with the payment processor, where the mobile account of the user is linked with the phone number of the user device of the user and process a payment from the mobile account of the user by utilizing the phone number of the user device of the user for authenticating the payment.

### FIELD OF THE DISCLOSURE

The instant disclosure relates to systems and/or methods for processing payments. More specifically, the instant disclosure relates to systems and/or method for processing micropayment transactions (i.e., transactions of $2 or less).

### BACKGROUND

Generally speaking, processing small payment amounts, for example 1 cent, has been challenging to implement because transaction costs with traditional processing are higher than the payment amounts, if such amounts are small. Processing costs are typically recovered from the buyer or the merchant as transaction fees. Conventional payment processing requires multiple intermediaries, beyond the buyer and merchant, who get a percentage of the fees charged for each transaction. To ensure profitability, fees are structured as a percentage on top of a minimum flat fee e.g., 2%+20 c to allow all the processing parties at a minimum to recover their transaction costs. These fees are usually paid by just the merchant for credit card transactions but may be paid by the user or split between merchant and user in other forms of payment. Credit cards when used for online payment, typically charge the merchant 20 c+2% per transaction, which sets the fee floor at 20 c. This means items costing 20 c or less, and any item with a gross margin less than 20 c cannot be profitably sold by credit card. On gross margins of 10% a sale by credit card is only profitable for amounts over $2. This characteristic is used to define micropayments loosely as payments under $2.

The problems encountered in processing micropayments using current processing methods is best illustrated with an overview of a purchase by check involving 4 parties: buyer, seller, buyer's bank and seller's bank. The check has the user's bank account number, a unique identifier of the bank where that account resides (called the routing number), the name of the check writer or account holder and often his address. The parties are the depositor, or drawer who is the account owner, and the drawee, or the party directed by the depositor to pay the check amount to the person presenting the check called the payee. For example, if you are cashing a paycheck, the bank that cashes your check is the drawee, your employer who wrote the check is the drawer, and you are the payee. The check is a proxy for currency, that names a party, the payee, who can draw a stated amount from a specific account in a specific bank. The check writer (drawer) typically signs the check with his signature which humans use to visually validate it.

When a buyer pays a seller by check, the seller presents the check to his bank (seller's bank), who identifies the buyer's bank from the check and forwards it to them. The buyer's bank deducts the check amount from the buyer's bank account and informs the seller's bank. Funds must now move between the banks, in a separate step called settlement. The actual movement of funds between the banks can be done in several ways. The most common is where each bank holds an account with a third party, called a clearing house, which is debited or credited at intervals with net amounts for transactions between the banks. For example, three banks will net the total transactions between each other, and receive credits or debits to their deposits at the clearing house.

After the transaction settles, the seller's bank sends a message to the seller confirming that funds from the check have been applied to his account. The seller can then release the goods purchased to the buyer. This entire process is long. So, in practice, the seller accepts the check, and releases the goods, even before receiving confirmation from his bank that the buyer's check has cleared. This means there is a significant risk of fraud as the buyer may: i) have no funds or insufficient funds; ii) have no bank account; or iii) may have a check written against his account unbeknownst to him. The buyer gets a monthly statement but is not informed when funds are drawn from his account. These risks can be mitigated if payment processing is fast, check verification is robust (not dependent on visual signature comparison by humans), and transacting parties get confirmation of settlement before concluding the transactions. None of this is currently available with a check payment. Electronic processing is required.

Making the transaction electronic adds speed, uses a digital substitute for the check that can be robustly authenticated, transmits messages between transacting parties electronically, and may be designed for real time settlement, i.e., actual currency movement from the buyer's bank to seller's bank. Credit Cards are the dominant form of electronic payment processing. However, it adds several additional parties to the processing flow:
1. A payment processor to handle recording the transaction, crediting and debiting transaction parties, transmitting messages between parties, and authorizing movement of funds between banks (or the depository institutions that hold the actual funds). This processor for a branded debit card transaction is the brand itself (like Visa®, Mastercard®, etc.). It provides the network that connects the banks, records the transactions, and on a daily basis sends each bank a file showing all of its transactions, debits and credits, and the net actual cash the bank has to send to other banks for settlement. Each transaction carried on the brands network is also checked for fraud and evaluated for security.
2. A bank to issue credit cards. The credit card brand does NOT issue credit cards. It just provides the network, records transactions, aggregates the transactions of each bank, and sends each bank on its network a net settlement amount. Each bank then sends or receives those net balances from other banks in settlement. The credit card brand charges a fee for these services. So, the credit cards and debit cards of the brand are issued by banks to account holders, but the transactions originated with these cards are recorded by the credit card brand and carried on its network. For debit card transaction settlement, the funds are taken from the buyer's bank account, while for credit card settlement, the funds are taken from a credit line, granted to the account holder by the card issuer on agreed upon interest and repayment terms. Debit card transactions may also be carried on different networks. Processing is otherwise identical. The processing overhead, including risk mitigation, is tolerable for a $100 transaction but not for 10,000 transactions of 1¢ each, also totaling $100. So, for a credit card purchase, the buyer gets a credit card issued by a bank, called the issuing bank. The credit card has a unique numeric identifier, the credit card number, comprised at a minimum of an identification number for the issuing bank—called a Bank Identification Number (BIN)—and the account number of the buyer at that issuing bank (similar to the routing number and account number combination on a check).
3. An acquirer who connects the merchant to the credit card brand's network. Although a transaction still involves the buyer and the merchant, the merchants will not have a connection to the processor's network. The processor (i.e., Visa® or Mastercard®) contracts with agents connected to its network called acquirers, who are usually banks, who connect the merchant to the processor network, and ultimately to the buyer's card issuer, the issuing bank. The acquirer creates an account for the merchant to which funds for his sales transactions are credited. The acquirer may also provide the merchant with devices, such as point-of-sale terminals, that read a Debit Card, and transmit its information along with transaction details to the acquirer.
4. An acquirer's processor who connects the acquirer to the branded network, as most acquirers do not have a direct connection to the credit card network and need to go through a third-party processor.
5. If the transaction is online, it is routed through a gateway before it gets to the acquirer. So, including the user and the merchant, there can be 7 parties or more involved in a single credit card transaction.

When the credit card brand receives a transaction, it routes it to the issuing bank, identified from its BIN (Bank Identification Number) which is part of the credit card number. The issuing bank will then check the account of the buyer, which is also part of the credit card number, confirm that he has enough cash to cover the transaction. It will then place a hold on the transaction amount and send a confirmation to the credit card company. The credit card company then sends approval to the acquirer, via its processor, who in turn, sends the approval on to the merchant. The merchant can then release the goods purchased to the buyer.

The merchant however does not receive the funds for the goods sold until after settlement. This happens only after the credit card company sends out a summary of interbank transactions to the banks in its network, so that they can send and receive net amounts from other banks as settlement for transactions. The banks have several ways of effecting the actual money movement for settlement. They may send a message to a clearing house, an entity through whom participating banks exchange net amounts as debits and credits to settle debt. Popular clearing houses such as the Automated Clearing House (ACH) may take up to 3 days to settle a transaction. Another method of settlement is to send a message to the Federal Reserve Bank, where all banks are required to keep deposits, requesting transfer of funds between the deposit accounts of the buyer's bank and the seller's bank. All these message transmissions take place on a network and require network and computer infrastructure.

So, electronic processing, under the current credit card processing model INCREASES the number of processing participants and the network overhead, infrastructure, and compute, memory and storage costs for individual transactions. If the transaction amount is small, like a micropayment, these costs make processing unprofitable.

Credit card companies and card processors try to circumvent this problem by allowing merchants to bunch small transactions performed by a user within a specific time interval (e.g., 5 days) before submitting a charge to the processor. This process, called aggregation, is designed to increase the amount submitted, so it resembles a single large transaction and can be processed with one network call allowing both the merchant and the processors to make a profit. Aggregation also means that transactions cannot be performed in real time as the merchant either must release the goods before charging the user's credit card (would you wait 5 days for a 10 c transaction to clear?) or wait till enough transactions are performed by that user, aggregated and then charged, before releasing the goods.

Past approaches for processing micropayments included trying to reduce network communication by enabling the merchant to independently validate payments without making a call to the issuer (i.e., simulating cash payment). This approach depended heavily on public/private key encryption. A message encrypted with a private key can only be decrypted with the equivalent public key. In this process:
1. A bank would create a file called a token, with a dollar face amount, similar to a bank check; deduct its face amount from the user's bank account; and then sign the token with its private key. This token is now currency and can be used as payment.
2. The bank issuer makes his public key widely available, so that any token it issues can be validated for both amount and issuer identity by any merchant with the public key.
3. When the token is presented as payment, the merchant decrypts it with the public key of the bank, which validates the token amount and the bank issuer. The merchant can then release the goods purchased. The merchant will later present the token to the bank issuer for cash.

The purpose of the token was to circumvent the need to make network calls to the issuer to validate the token and instead have any merchant validate the payment directly i.e., just like accepting cash. However, these schemes failed for many reasons:
a. Public/key encryption was computationally intensive and slow, which raised per transaction costs so large, transactions volumes could not be processed at high speed.
b. The solution provided no protection against “double spending”. Double spending, which is the equivalent of physical currency counterfeiting, occurs when a token is copied and spent more than once. Since a token is digital, exact copies can be made easily and spent multiple times. Each copy will have the correct private key signature and will pass public/private key validation. Contacting the token issuer to determine if a Token had been previously redeemed, re-introduces the network overhead which Tokens were created in the first place to avoid.
c. The token solution is not fungible as the token must be issued in multiple denominations that would allow the buyer to pay any amount. For example, with only 25¢ and 50¢ token denominations, a buyer cannot pay for an item costing less than 25¢, or whose price is not a factor of 25 e.g., 77¢.
d. Bank issuers then tried to have the token loaded into a smart card [a small computing device, the size of a credit card, with a chip, storage, and memory]. The goal was to make the token inaccessible and unavailable to be copied. However, this meant that every buyer would have to purchase and carry a smart card, and every seller needed a special point-of-sale terminal capable of reading these smart cards. The requirement for seller and buyer to have specialized devices stifled adoption. All micropayment token systems failed.

These and the additional problems listed herein for processing micropayments may all be solved by the instant disclosure. These additional problems may include, but are not limited to:
1. Processing Time—Processing of each micropayment transaction has to be very fast and minimize processing time. Consumers will tolerate longer wait times for large transactions but not for small transactions e.g., a 5¢ purchase. Traditionally, processors lease or buy large amounts of compute power, storage, in multiple datacenters in specific low-cost locations connected by high-speed networks. All transactions are routed to these locations, so round-trip times are large and consumer waits are long. Again, this is tolerable for macropayments (amounts over $2) but not micropayments. Minimizing compute costs requires a “pay-as-you-go” model while minimizing network roundtrip times requires processing close to the merchant.
2. Security—Micropayment transaction amounts, though small, must be secure, reliably captured, and have robust-yet-low-cost protections, against loss and fraud. Security must be designed into micropayments processing and cannot be a costly add-on. Credit cards for example, are primarily bearer instruments, wherein any person in physical possession of a credit card can use it for purchases in a store, and worse still, physical possession of the card is not needed to pay online. This means that stolen cards and cards obtained from credit card breaches can be used online with impunity. Therefore, credit card fraud, already high at 7% of card revenues, continues to rise, and 81% of that fraud is online. To address this, credit card companies like Visa® perform up to 500 fraud checks on each credit card transaction and use a slew of algorithms to try and identify fraudulent transactions. The cost of such fraud checks is untenable for say a 20¢ transaction if security costs are not to dwarf the payment amount.
3. High Transaction Volumes—Micropayment processing infrastructure must be able to handle very large transaction volumes since many more micropayment transactions are needed to reach any target revenue amount. For example, 10,000 1¢-transactions are needed to reach $100 in revenues. Payment processors, such as Visa®, already process trillions of transactions a year, almost entirely payments above $10, so their infrastructure would require significant investment, to handle large additional volumes required for micropayments. Such investments will increase per transaction costs and adding micropayment processing may jeopardize their existing processing operations.
4. Costs per transaction—Micropayment processing is infeasible for credit card processors like Visa®, MasterCard® etc., and systems on credit card rails, i.e., systems that ultimately depend on credit card rails like PayPal®, Square® etc. Also, traditional processors require large, fixed infrastructure built to handle target transaction volumes. For example, if a Processor's investment today to process 10 million transactions a month over 3 years is $30 million, and network and operating costs over the same 3-year period is $6 million, then annual amortized costs of operations is $12 million [(30+6)/3] or $1 million per month. For 10 million transactions a month, this translates to 10¢ per transaction [1,000,000/10,000,000]. This is the average processing cost per transaction. The processor's fees at a minimum must cover this cost.
5. Infrastructure Costs—In addition, the infrastructure of a payment processor must be built to handle peaks e.g., for sales on “Black Friday”. So, if the processor anticipates peak transaction volume of 1 million a day a few times a year, which is 3 times its current capacity, then it needs larger infrastructure to handle these peaks. Assuming this requires infrastructure, whose amortized monthly costs is $2,000,000 instead of $1,000,000, then since processing volume is still roughly 10 million transactions a month, per transaction costs rise from 10¢ to 20¢ per transaction. Addressing peaks by investing in extra infrastructure that is mostly idle except for times of peak processing is the traditional model used by payment processors, but it causes a steep rise in their per transaction costs.
6. Proprietary Networks—Almost all major payment processors today including Visa®, MasterCard®, Amex®, Discover® and almost all banks, predate the internet and have their own networks and payment processing infrastructure. For example, Visa® has massive data centers across the globe, and owns VisaNet®, it's private network. which predates the internet and carries nearly all of Visa's® transactions. These networks are very expensive to build and maintain and increase fixed costs which in turn raise average per transaction costs. A micropayment processor cannot require a proprietary network. Online Credit Card processing fees come to about 2%+20¢ per transaction, and is split, between the issuing bank, the processor, the Acquirer, and the network owner. It must be kept high enough to allow these parties to recoup their costs. On a $100 transaction, the merchant typically receives $97.25, while $2.20, 23¢, 19¢ and 13¢ go to the issuing bank, payment processor, acquirer, and network owner respectively. A micropayment processing invention must minimize the number of intermediaries.
7. User Authentication—Credit cards are bearer instruments designed for in-person transacting and physical possession of the card. When a user swipes, taps or inserts a card in a seller's Point-Of-Sale (POS) terminal to make payment, it is called a card present (CP) transaction, If the user makes a purchase online, which does not require a physical card, it is called a card-not-present (CNP) transaction. CNP transactions are much more difficult to validate and hence riskier. CNP fraud is 81 percent more likely to occur than in-store or CP fraud. This higher risk is why online credit card transactions, which are CNP, have higher fees. A micropayment processing invention requires robust yet inexpensive methods of user validation.

Accordingly, there is clearly a need to provide new systems and/or methods of processing micropayments that can be provided with lower fees, while still providing secure and robust transaction processing. The instant disclosure may be designed to address at least certain aspects of the problems noted above by providing the disclosed system and methods of processing micropayments.

### SUMMARY

The present disclosure may solve the aforementioned limitations of the currently available methods and systems for processing transactions by providing the disclosed methods and system for processing micropayments. The disclosed system and method for processing micropayments generally includes a user device, a network, a payment processor, and a client application. The user device of a user includes a processor, memory, and a phone number. The user device is configured to communicate over or on the network. The payment processor includes a processor and memory and is in communication with the user device over the network. The client application is installed on the user device of the user. The client application is configured to process payments through the payment processor from the user over the network. Wherein the client application is configured to: create a mobile account of the user with the payment processor, where the mobile account of the user is linked with the phone number of the user device of the user; and process a payment from the mobile account of the user by utilizing the phone number of the user device of the user for authenticating the payment. Wherein, the payments processed from the mobile account of the user can only be initiated from the user device of the user because the phone number of the user device is linked to the mobile account of the user and is used to authenticate the payment.

One feature of the disclosed system for processing payments is that the client application is configured to create the mobile account of the user with the payment processor on a processing cluster by signing up the user with the payment processor with required security credentials of the user and the phone number of the user device of the user and saving it on the processing cluster. Where the payment processor saves the required security credentials of the user to the mobile account of the user and links the phone number of the user device to the mobile account of the user on the processing cluster.

Another feature of the system for processing payments of claim may be that the client application can be configured to process payments from the mobile account of the user and always display a balance of the funds of the user in real time on the user device of the user.

Another feature of the system for processing payments of claim may be that the client application can be configured to process payments from the mobile account of the user by generating a PIN on the user device of the user. Wherein, the PIN may be generated by the user entering a payment amount and encoding the payment amount with an expiring OTPIN. Wherein, when the PIN is generated, the payment amount may be deducted from the funds of the mobile account and the PIN may be sent to the payment processor before displaying it to the user on the client application.

Another feature of the system for processing payments of claim may be that the expiring OTPIN may be encoded using a key downloaded from the payment processor over the network which may be derived from the phone number of the user device of the user and may therefore be unique to the user device of the user.

In select embodiments of the disclosed system for processing payments, when the user provides the PIN generated by the client application and the phone number of the user device of the user to a merchant, and the merchant sends the provided PIN and the provided phone number to the payment processor over the network along with an item price, the payment processor may be configured to decode the PIN into the OTPIN and a decoded payment amount for the payment processor, and the payment processor may be configured to authenticate the following: the decoded payment amount equals the payment amount; the OTPIN has not expired; the PIN was generated on the user device of the user that wrote the PIN via the phone number of the user device; and the funds of the payment amount were deducted from the mobile account of the user.

In select embodiments of the disclosed system for processing payments, when the merchant submits a file of an approved transaction via an API call to the payment processor, the payment processor may be configured to identify if the approved transaction is valid and credit the merchant the payment amount minus any transaction processing fees.

In select embodiments of the disclosed system for processing payments, the payment processor may include a bank. The bank may be configured to hold the funds of the user and funds of the merchant for use in the system. The bank may also be configured to move funds of the user and the merchant in and out of the system over the network through the client application by either a funds transfer from a different bank account, using common methods including ACH, RTP, or Fedwire, by depositing a check, by charging a credit or debit card, and/or by paying cash to an agent of the payment processor.

Another feature of the system for processing payments of claim may be that the user device is a mobile phone assigned with the phone number.

Another feature of the system for processing payments of claim may be that the payments processed from the mobile account of the user are micropayments.

Another feature of the system for processing payments of claim may be that the PIN validation by the payment processor takes less than 400 milliseconds.

Another feature of the system for processing payments of claim may be that the system for processing payments may be configured to process ten million micropayment transactions in under 10 seconds.

Another feature of the system for processing payments may be that the payment processor authenticates the payment by the user without requiring entry of personal information of the user.

In another aspect, the instant disclosure embraces the system for processing payments in any embodiment and/or combination of embodiments shown and/or described herein.

In another aspect, the instant disclosure embraces a method for processing payments, like by utilizing the system for processing payments in any embodiment and/or combination of embodiments shown and/or described herein. In select embodiments, method for processing payments may generally include: installing a client application on a user device of a user, the user device including a processor, a memory, and a phone number; signing up the user with a payment processor through the client application on the user device including providing all required security credentials; submitting the phone number of the user device to the payment processor through the client application on the user device; assigning a mobile account to the user and saving the provided required security credentials of the user along with the associated phone number of the user device of the user in the assigned mobile account with the payment processor; linking the user device of the user to the assigned mobile account of the user via the phone number of the user device, wherein the user can process payments only from the linked user device via the phone number of the user device; adding funds to the assigned mobile account of the user by transferring money to the assigned mobile account; and processing a payment from the user via the client application on the user device of the user by authenticating the payment via the phone number of the user device of the user.

One feature of the disclosed method for processing payments may be that the client application can be configured to create the mobile account of the user with the payment processor on a processing cluster by signing up the user with the payment processor with required security credentials of the user and the phone number of the user device of the user and saving it on the processing cluster. The method may then further include the payment processor saving the required security credentials of the user to the mobile account of the user and linking the phone number of the user device to the mobile account of the user on the processing cluster.

Another feature of the disclosed method for processing payments may be that the client application can be configured to process payments from the mobile account of the user and may include always displaying a balance of the funds of the user in real time on the user device of the user.

Another feature of the disclosed method for processing payments may be that the client application can be configured to process payments from the mobile account of the user by: generating a PIN on the user device of the user, wherein, the PIN is generated by: the user entering a payment amount and encoding the payment amount with an expiring OTPIN; wherein, when the PIN is generated, the payment amount is deducted from the funds of the mobile account and the PIN is sent to the payment processor before displaying it to the user on the client application. In select embodiments, the expiring OTPIN is encoded using a key downloaded from the payment processor over the network which is derived from the phone number of the user device of the user and is therefore unique to the user device of the user.

Another feature of the disclosed method for processing payments may be that when the user provides the PIN generated by the client application and the phone number of the user device of the user to a merchant, and the merchant sends the provided PIN and the provided phone number to the payment processor over the network along with an item price, the payment processor decoding the PIN into the OTPIN and a decoded payment amount for the payment processor, and the payment processor authenticating the following: the decoded payment amount equals the payment amount; the OTPIN has not expired; the PIN was generated on the user device of the user that wrote the PIN via the phone number of the user device; and the funds of the payment amount were deducted from the mobile account of the user.

Another feature of the disclosed method for processing payments may be that when the merchant submits a file of an approved transaction via an API call to the payment processor, the payment processor identifying if the approved transaction is valid and crediting the merchant the payment amount minus any transaction processing fees.

In select embodiments of the disclosed method for processing payments, the payment processor may include a bank. The bank holding the funds of the user for use in the system. The bank also moving funds of the user in and out of the system over the network through the client application.

In select embodiments of the disclosed method for processing payments, the user device is a mobile phone assigned with the phone number.

In select embodiments of the disclosed method for processing payments, the payments processed from the mobile account of the user are micropayments.

Another feature of the disclosed method for processing payments may be that PIN validation by the payment processor takes less than 400 milliseconds.

Another feature of the disclosed method for processing payments may be that it can be configured to process ten million micropayment transactions in under 10 seconds.

Another feature of the disclosed method for processing payments may be that the payment processor authenticates the payment by the user without requiring entry of personal information of the user.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a schematic flow diagram of a method and/or a system for processing micropayments according to select embodiments of the instant disclosure;

FIG. 2 is a schematic flow diagram showing PIN Generation according to select embodiments of the instant disclosure for use in select embodiments of the disclosed methods and/or systems for processing micropayments;

FIG. 3 is a schematic flow diagram showing the processing cluster of a payment processor according to select embodiments of the instant disclosure for use in select embodiments of the disclosed methods and/or systems for processing micropayments;

FIG. 4 is a schematic flow diagram showing a processing cluster according to select embodiments of the instant disclosure for use in select embodiments of the disclosed methods and/or systems for processing micropayments;

FIG. 5 is a schematic flow diagram showing hierarchy for processing cluster name resolution servers according to select embodiments of the instant disclosure for use in select embodiments of the disclosed methods and/or systems for processing micropayments;

FIG. 6 is a schematic flow diagram showing a phone number to processing cluster address resolution according to select embodiments of the instant disclosure for use in select embodiments of the disclosed methods and/or systems for processing micropayments;

FIG. 7 is a schematic flow diagram showing a process cluster address resolution and federation according to select embodiments of the instant disclosure for use in select embodiments of the disclosed methods and/or systems for processing micropayments;

FIG. 8 is a schematic flow diagram showing processing cluster database splitting according to select embodiments of the instant disclosure for use in select embodiments of the disclosed methods and/or systems for processing micropayments;

FIG. 9 is a schematic flow diagram showing transaction processing with accounts on one processing cluster according to select embodiments of the instant disclosure for use in select embodiments of the disclosed methods and/or systems for processing micropayments;

FIG. 10 is a schematic flow diagram showing transaction processing with accounts on two processing cluster according to select embodiments of the instant disclosure for use in select embodiments of the disclosed methods and/or systems for processing micropayments; and

FIG. 11 is a schematic flow diagram showing image authentication according to select embodiments of the instant disclosure for use in select embodiments of the disclosed methods and/or systems for processing micropayments.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

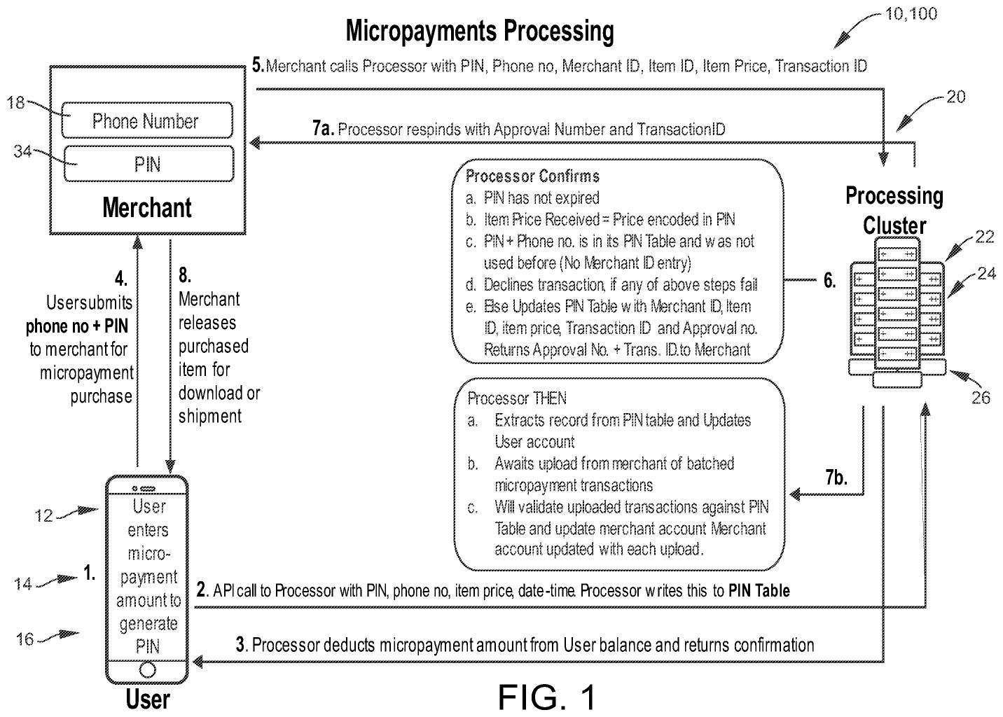

Referring now to FIGS. 1-11, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices and methods of processing transactions by providing system 10 and method 100 for processing micropayments. For reference, the following terms and definitions thereof may be used for reference throughout the instant disclosure when describing system 10 and method 100 for processing micropayments.

### Definitions of Terms Used in this Disclosure

Device Application: Also, Device app or Client Application. The payment application installed on a device which is used to make and receive payments.

DNS: Domain Name Service which is a way of resolving the fully qualified domain name (e.g., www.uspto.gov) of a computer to its underlying IP address (e.g., 192.168.1.6).

Double Spending: This is a problem in which the same digital currency—often represented as a digital file or digital token—is copied and spent more than once: A single digital token is copied and used over and over to pay for purchases. Because it is digital, it will pass all validation checks. So, without consulting the issuer, there is no way to determine if in fact a token has been spent before. This is digital counterfeiting, and since making a digital copy is easy, millions of copies of a single payment token can be made easily and used repeatedly for payment. Double spending is a major problem for token-based currency systems.

Image Block: Block of multiple images, for example, 35 thumbnail images in a 7×5 block, displayed on a user device. The user selects one or more images from this block during registration which becomes their image credential used for authentication. Subsequently, the user selects this image from a block of images each time authentication is required. The image serves as a password but is much faster to select than typing in a password; the user simply taps their image to select it from the image block. It is also more difficult for non-humans to identify images from a block of images. The user may select two or more images from a single block of images and may be required to select these images in a specific order. For layered authentication, the user may first select an image and then select features within the image by clicking that feature from an enlarged version of the selected image e.g., clicking the bicycle in an image of a red car and a blue bicycle. So, the user may select one image, or select multiple images in a specific order from the same block of images or select different images from different unique blocks of images, or may select an image and then additional features within that image for further authentication. The use of images for authentication is discussed in detail below in the specification.

Macropayments: Larger payments or payment amounts over $2. It's the converse of micropayments which is amounts under $2. So, $2 is the ceiling for a micropayment transaction. The $2 amount is partly arbitrary, as it is derived by combining the average credit card fee of 2%+20 c for an online transaction with the average merchant margins of 10% on small ticket items. Both conditions mean that sale of a $2 item by credit card will result in a loss to the merchant.

Merchant: This is the person, an entity, or device to which payment is made, that is the payment recipient. The underlying reason for the payment need not be considered. So, payment may be for a purchase, a remittance, a gift, a transfer to a person, entity or device representing the merchant.

Micropayments: Defined in this invention as any amount under two dollars ($2.00). The $2 amount is partly arbitrary, as it is derived by combining the average credit card fee of 2%+20 c for an online transaction with the average merchant margins of 10% on small ticket items. Both conditions mean that sale of a $2 item by credit card will result in a loss to the merchant. Micropayment processing requires methods that allow processing of large volumes of micropayments at very low marginal cost per transaction. The marginal cost must be lower than the transaction fee for processing to be profitable. For example, the marginal cost of processing a 1 c transaction must be below 1 c.

Micro-price: Any price that is $2.00 or less. Also used as a verb (e.g., Micro-pricing, micro-priced).

Mixing Function: A mathematical function that takes one or more inputs and a key and generates a fixed length PIN as output. Unlike a hashing algorithm, that uses a one-way function, where the inputs are difficult to derive from the output, the mixing function is also an inverse function and returns the inputs when fed the PIN and the same key used to generate it. It should be computational infeasible to derive the PIN or it's inputs without the key.

Mobile Device: Also, Device. Same as mobile phone, tablet, computing or IOT device. Mobile phone is used throughout this invention to represent possible computing devices used to make payment.

OTPIN: One-Time PIN which expires after a fixed but configurable time interval. It is one of the two components of the PIN; the other is the item price. In this invention, the PIN and mobile device number submitted as a pair represent currency and can be used to make payment before the PIN expires. The OTPIN is created by encrypting current time and an expiration interval with a specified key. The same key is used to decompose the PIN and validate the OTPIN. The process of creating and validating an OTPIN is well known and documented in RFC 4226 and 6238. The expiration time of the OTPIN can be short (e.g., 30 seconds) or arbitrarily long e.g., (14 days). OTPINs with long expirations are used for long-lived PINs.

Pay-Per-Click: Clicking on an icon, or item in a phone, browser, TV or similar electronic screen to pay for a purchase.

Payment Processor: Also, Processor or Micropayment Processor. The entity that processes payments between transacting parties such as between users and merchants, users and users, users and banks, merchants, and banks, where users, merchants and banks, may be persons, entities or devices. In this invention, Payment Processing is handled by software processes attached to a database that function as a unit called a Processing Cluster (see below). A Payment Processor may have more than one Processing Cluster. Also, a Processing Cluster can be dedicated to a single merchant or to multiple merchants, while a very large merchant may be assigned more than one Processing Cluster.

Per transaction costs: Also “cost per transaction”. This is the cost of processing a single payment transaction. It represents the marginal cost for an additional transaction and must be below the transaction amount otherwise a loss results to the processor. The processing fee charged by the Processor need to be equal to or higher than the marginal cost for processing.

PIN: Personal Identification Number. In this invention, the PIN is generated on the user's mobile device for each payment transaction and submitted with his phone number to the merchant, either directly from the phone or via a website or via any interface provided by the merchant. The PIN expires within a specified interval (e.g., 30 seconds) after which it cannot be used. The PIN is comprised of the payment amount and a cipher text resulting from encrypting the current time with a key. The key, which is derived from the device phone number, combines the current time with item price, in a mixing function that outputs the PIN. The PIN can be used as payment for any transaction amount before it expires. It is ideal for micropayments because PIN creation and validation requires very little compute resources. Light weight processes on the phone generate the PIN using a phone number-specific key; the same key is also used by the Payment Processor to validate the PIN. PIN validation takes milliseconds, incurs very little overhead, and can be performed by large numbers of independent processes that do not need to read a table, or access a database.

Processing Cluster: Also, Cluster, Processing backend. A group of compute, storage, network, software, and database resources, that function as a unit for payment processing. Each Processing Cluster holds a set of user records, and processes payments for those users. Processing requests for a user must be directed to the Processing Cluster that holds that user's records. Per transaction costs for each Processing Cluster is kept at a target minimum, up to a given processing rate for example 1,000 transactions per second. Beyond this volume threshold, an additional Processing Cluster is automatically spawned to prevent increase in per transaction costs. Each Processing Cluster uses technology services from Cloud Providers charged in hourly, minute, second or millisecond time increments, called utility billing. These services are consumed as utility services from Cloud providers who have made huge infrastructure investments which they amortize across the millions of users they serve; Cloud users get infrastructure that is metered and that can automatically increase or decrease to meet demand and for which no payment is made when the service is not in use. With Utility pricing, a Payment Processor instead of acquiring large amounts of fixed compute infrastructure, which raise cost per transaction and require millions of transactions to breakeven, can have a much smaller initial infrastructure investment since the infrastructure grows and shrinks as transaction volumes rise and fall. This produces very large savings and reduces per transaction costs, which remain flat across transaction volumes. With this model, a Processing Cluster can handle 1,000 transactions per second (86.4 million transactions a day) at a cost of under 1¢ per transaction.

Recipient: The User, merchant or bank who receives a mobile money transfer or transaction payment.

Utility Computing: A computing model where computing service are provided on a “pay-as-you-go” basis, like a utility, and are billed in time increments which may be per day, per hour, per minute, per second or per 100 milliseconds. This utility model offered by Cloud Service providers is now widespread and its use is assumed in this invention.

User: Also, payer, payor, sender, buyer. The person, device or entity that makes or receives payment.

### Summary of System and Process for Micropayments

Referring now to FIG. 1, making a micropayment requires user device 12 with processor 14, memory 16, a unique identifier like phone number 18, able to communicate on network 20, and have storage, enough to hold tiny client application 30. Such user devices 12 can include mobile phones, tablets, computers, IOT devices etc. All such devices are hereinafter referred to as a mobile app device, mobile device, or simply device. Though the invention is specific for micropayments, it can be used for processing larger payments and may produce much higher margins as the low cost per transaction remains virtually unchanged even for large amounts. Performing micropayments involves 4 participants: a user, a merchant (or recipient) 38, and a Payment Processor (Processor) and a bank where the user and merchant funds reside. The bank is only involved in movement of funds into or out of the user's mobile account 34 or the merchant's account.

First, the user installs client application 30 (the device app) on his mobile device 12. He uses this app 30 to sign up with the Payment Processor which may require that she provide personally identifiable information, e.g., full name, address, date of birth, place of birth, email, etc., and choose a password and any other required security credentials. The device phone number 18 or other unique device identifier is submitted to the Payment Processor by the mobile app 30 for the device 12. The Processor saves this information. The user is then assigned an account called the mobile device account, which is like a bank checking account opened for the user by the Payment Processor, who then links the device to the user's mobile account 34. This becomes the user's default device; it is the only device with which the user can perform transactions. The Processor needs to have a bank partner that opens accounts for its user's and merchants, or itself be a bank.

The user adds funds to his mobile device account by transferring money to it either by a funds transfer from a different bank account, using common methods such as ACH, RTP or Fedwire, or by depositing a check, or by charging a credit or debit card, or by paying cash to an agent of the Payment Processor. The device account holds the funds from which all payments, debits, credits, and all money movements occur for that user. The user can connect to this device account only from his or her default device 12 which always displays his or her cash balance and so makes it appear as if the account is literally on the mobile device. By default, transactions are possible only from this one user device 12, though the user can switch to another device or authorize use of more than one device for making payments.

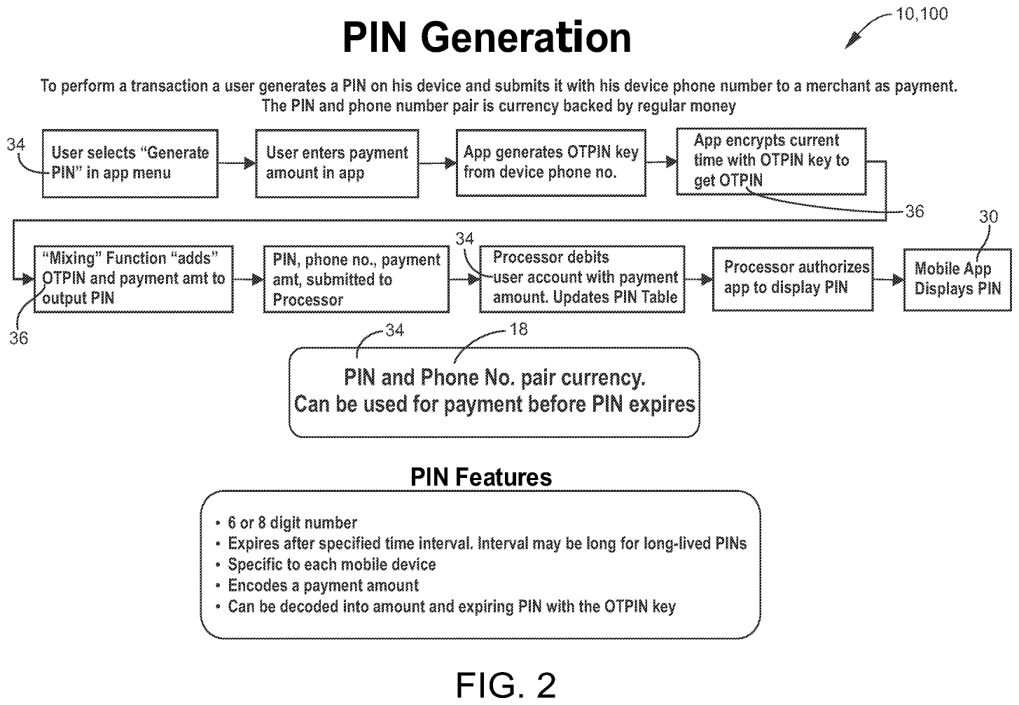

Referring now to FIG. 2, to make an online purchase, the user generates PIN 34 on their user device app 30 by entering the micropayment amount she wishes to pay. The device app 30 first writes this PIN to the Processor before displaying it to the user. The PIN is an encoding of the payment amount with an expiring One-Time PIN (OTPIN) using a key, downloaded from the Processor which is derived from the mobile device phone number 18 or identifier, and is therefore unique for each mobile device.

The user enters the PIN 34 and his mobile device phone number 18 at or with the merchant 38. This entry could be made in a web browser for online payment, or into a point-of-sale (POS) terminal at a physical merchant 38. Entry at a physical location may be manual, or wireless.

The merchant 38 may then send the device phone number 18 and PIN 34 with the item price, transaction ID and his own merchant ID (obtained during merchant registration with the Processor) to the Payment Processor in an API call.

The Processor may then: decode the PIN 34 into OTPIN 36 and amount; confirm that the decoded amount entered by the user equals the amount submitted by the merchant 38; that the OTPIN 36 has not expired; that it was generated on the same device that wrote the PIN 34 to the Processor via phone number 18; and that the phone number PIN pair has been funded. Validation of PIN 34 may take less than 400 milliseconds, and may solve in one shot, 3 of the key security problems of micropayments: it may authenticate the user for each transaction without requiring entry of personal user information (e.g., name, address, billing address, etc.), it may support transaction online and offline, and may require only 3 parties: buyer, seller and Processor. In addition, it may prevent double spending, may eliminate pricing fraud by merchant 38 or user, and may confine an attack to the expiration window of the PIN 34.

When the merchant 38 receives approval, he gets an Approval Number and can release the goods paid for. The Processor is confident since the payment amount has already been taken from the user. The merchant 38 will have to show that he has released the goods to the user, for the credit to be applied to his merchant account. To do this, the merchant 38 periodically submits a file of approved transactions to the Processor, who identifies all the valid transactions and credits the merchants with the sum of the transaction amounts less any transaction processing fees. Ten million micropayment transactions can be checked and credited to the merchant's account in under 10 seconds. The merchant 38 can log into his account to see the transactions credited to his account.

Second, referring now to FIGS. 1, and 3-10, payment processing by the Processor is performed on one or more Processing Clusters 22. A Processing Cluster 22 may be a single payment processing unit, comprised at a minimum of a load balancer, a compute node (which may be one or more containers with CPU or processor 24, memory 26, storage and network Interfaces) and a database that holds user and merchant records for that Processing Cluster 22. The Processing Cluster 22 may have additional resources e.g., a Content Deliver Network, a Hardware Security Module etc. The Processing Cluster 22 can be seen as a server node attached to a database behind a load balancer. The database holds the specific user records for that Processing Cluster 22. A Processing Cluster 22 since it primarily updates a database for each transaction, can have extremely low marginal cost for processing each transaction up to a given transaction volume. Note that Processing Clusters 22 have an “autoscaling” feature where the number of cluster nodes automatically increases with number of payment requests. This increase is triggered by a performance measure such as CPU utilization—a proxy for processing volume. When requests fall, CPU utilization falls, and the Cluster nodes are removed.

System 10 and method 100 may processes micropayment requests within the Processing Cluster 22 using specific Cloud services, priced in hourly, per second or per millisecond increments, so that per transaction cost is based on run duration of each service. Minimizing per transaction cost then becomes an engineering problem: keep processing time below a time target in order to stay below a cost target. For example, if Cluster charge is $0.000005 per millisecond, then marginal processing cost can be kept below 1¢, if processing time is kept below 2,000 milliseconds.

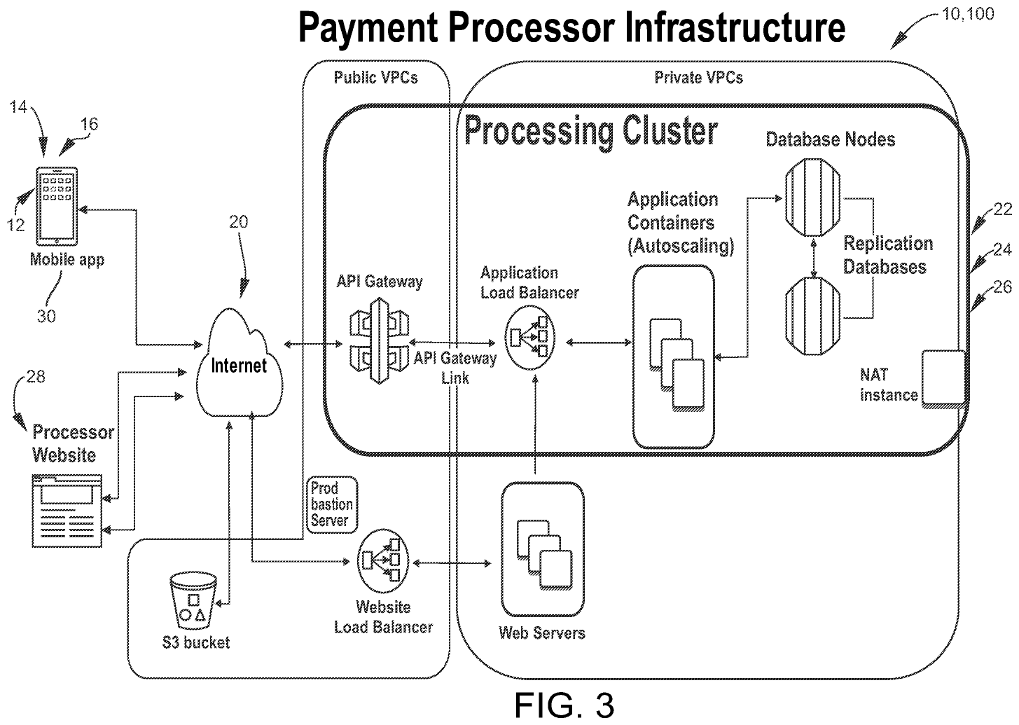

Third, this invention uses Serverless functions, Database Federation, and Automatic splitting of Processing Clusters 22 to improve performance and reduce cost. Federation uses a new method to identify the target Cluster that holds the user's phone number records. A summary diagram of such infrastructure of the payment processor 28 with processing clusters 22 is shown in FIG. 3.

One of the key elements of the disclosed system 10 for processing micropayments and/or method 100 of processing micropayments may be that the merchant 38 and user accounts are located in the same bank. This means that no intermediate processor is needed to move funds between the buyer and the merchant 38. A debit to a user and a credit to a merchant represent a book entry—an entry in a database table—which can be performed almost instantly. This applies not just to purchases between user and merchant 38, but also to movements of funds from user to user, from user to merchant 38, and from merchant 38 to merchant 38. [Embodiments that use more than one bank for co-location of accounts depend on the same logic as for one bank and are described below in the section “Multiple Bank Co-location”].

Every user who wishes to perform micropayments signs up and gets an account at a bank specified by the micropayment processor. The user loads this account with money using conventional methods: A check deposit, a cash deposit, ACH, a wire transfer, a debit card payment, a credit card payment, a direct deposit or any method used to place cash in a bank account. Unlike a conventional bank account, however, the user performs transactions on this account by making calls to the micropayment Processor from app 30 on his mobile device 12. The opening of the bank account is performed via app 30 and the user need not know the name or location of the bank where his funds reside.

Every merchant 38 who signs up to accept a micropayment gets a merchant account at the same bank. When a user performs a transaction, either with another user or with a merchant, his account represented as a record in a database table is debited and while an account represented by the merchant account is credited. There is no movement of funds out of the bank. For example, if two user's user 1 and user 2, load $100 and $200 respectively into their account, with a processor that has 1 merchant, with $0 in sales, the bank account of the processor now has $300 representing the total funds of user 1 and user 2, and merchant 1. Both users each proceed to make one thousand (1,000) 1 c purchases from the merchant totaling $10 each. Assuming we ignore fees for the moment, the micropayment processor captures all the transactions in its electronic ledger. Its ledger now shows: User 1 balance=$90; User 2 balance=$190; and Merchant 1=$20.

The processor's total cash balance at the bank is unchanged. Transactions can continue and will be captured as movements of funds in the electronic ledger between user and merchant 38 until the users run out of money. No actual movement of money occurs unless the user or the merchant 38 decides to move money from his account at the processors bank to another bank. Only the balance for that user as reflected in the electronic ledger is available to be moved out of the account. Such operations—involving movement of money out of the bank—can be performed by conventional methods e.g., ACH, ATM withdrawal, wire transfer etc. Each payment transaction between accounts i.e., user to user, user to merchant 38, or merchant 38 to merchant 38 are ledger entries and can be completed in milliseconds at near zero no cost.

The Processor can perform the equivalent of co-location of accounts at more than one bank if it has one Processing Cluster 22 that communicates with each bank or a Processing Cluster 22 for each bank where the Processing Clusters 22 communicate with each other. Getting the same benefits of co-location while using more than one banks is described herein with regards to Multiple Bank Co-location.

However, before the ledger entry, the user must make payment to the merchant 38 who then has to contact the micropayment processor to update the ledger entries. This part of the payment transaction between user and merchant 38 must be fast, efficient, secure, and low cost. Low-cost communication is achieved in this invention by using the following:
Internet as a Private Network 20—All processing is encrypted end-to-end and carried over the public internet, instead of a private or proprietary network. This minimizes transaction cost.
Eliminating Intermediaries—For a user to load his mobile account 34 with funds or for a merchant to sign up requires calls by the Processor to a bank. Thereafter, all payment transactions are between the user, merchant 38, and Payment Processor; there are no third-party intermediaries. The Processor may dedicate one Processing Cluster 22 to multiple banks or have one Processing Cluster 22 per bank or a mix of both.

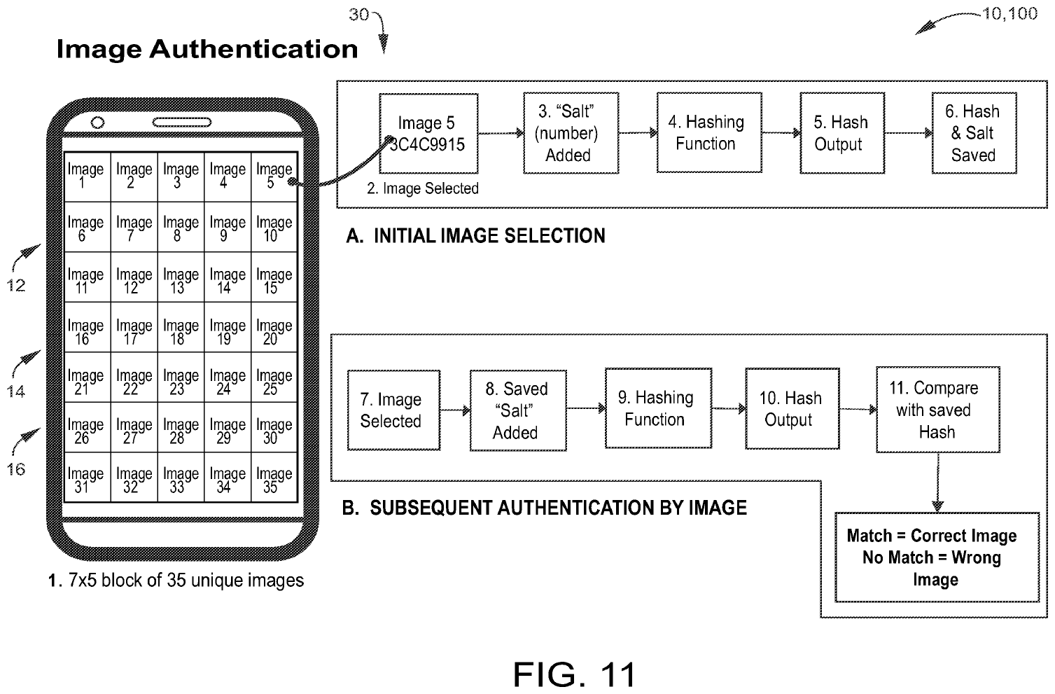

The user first installs the Processor's Payment app 30 on the user's mobile device 12, for example from the Apple® store or Google® Play Store or Processor's website. The user then signs up by providing personal information such as name, address, date of birth etc., selects a login name, login image, and password. The use of login image is described later under image authentication (see FIG. 11). The user then loads money into their mobile app 30 from their bank account or by debit card. Once the user's mobile device account is funded, the user is ready to transact.

To make a micropayment purchase from a website, the user selects the item and clicks “Pay” on the web page. This opens a dialog box with 2 fields, into which the user enters: a) Her mobile device phone number 18; and b) PIN 34, generated on their phone via App 300 and required for each payment transaction.

As best shown in FIG. 2, to generate PIN 34, the user clicks “Generate PIN” on the device app 30 on their mobile phone 12, where the user is prompted to enter the micropayment amount (i.e., item price) for which the user is making payment, following which PIN 34 is displayed. As an example, and clearly not limited thereto, the PIN 34 may expire in 30 seconds (this is configurable), must be used for a payment before it expires, and cannot be used more than once. The user's account balance, which is always displayed in the device app 30, is reduced by the micropayment amount entered. If the PIN 34 is not used and expires, the debit to their balance is reversed. The user submits the PIN 34 and their mobile number 18 to the merchant 38. The merchant 38, who must have registered earlier with the Payment Processor to accept payments, sends the PIN 34, mobile device number 18, item price, item ID, and transaction ID to the Processor's backend via an API call. If approved, an Approval Number is sent as confirmation to the merchant 38 who can then release or deliver the purchased item. The merchant 38 will periodically submit to the Payment Processor a file for all approved transactions, containing at a minimum, the item price and Approval number. The Processor validates each transaction in the file and credits the Merchant's account with the total payments received less the Processor's fee. See FIG. 1.

To make the above micropayment sequence possible, the present disclosure combines several technologies to minimize per transaction costs and processing time and handle large volumes securely.

### The PIN 34

The PIN 34 is generated by the user on his phone or user device 12 and entered into the merchant site along with his mobile device number 18 to make payment. For a micropayment transaction, the user must enter the payment amount (i.e., the item price) into his mobile app 30, which is used in generating the PIN 34. The amount entered is taken out of the user's mobile account 34 at the backend before the PIN 34 is displayed to the user. Once the PIN 34 is displayed it means the user's account has been debited for the amount contained in the PIN 34. At this point the mobile phone number and PIN pair represent currency.

The PIN 34 may be comprised of a One-Time PIN (OTPIN) 36 that expires in a fixed interval (e.g., 30 seconds) and a micropayment amount, (i.e., the item price) entered by the user on his device to generate the PIN 34. The OTPIN 36 may be generated using a library in the mobile app 30 and an OTPIN key, which is downloaded from the Processor and specific to each device phone number 18. This OTPIN key, OTPIN 36 and item price are run through a function—the “Mixing Function”—that outputs the PIN 34 and sends it to the Processor with the phone number 18 and item price via an API call. The Processor must give approval before the PIN 34 is displayed to the user.

A Mixing function is a symmetric key cipher function that “mixes” or encrypts inputs to get an output. Unlike a hash, it allows the input to be derived from the output and vice versa (see Mixing Function details below). The user submits his phone number 18 and PIN 34 to the merchant. Submission may be by entry into a website, or by transmitting the phone number 18 and PIN 34 as data directly to the merchant's receiving device. This can be done wirelessly.

The merchant, on receiving the phone number 18 and PIN 34, may call the Payment Processor's API with the PIN 34, and phone number 18 received, the item price (i.e., the micropayment amount), Transaction ID, (unique for each transaction), Merchant ID (merchant identifier obtained at Sign Up), date, and time. The call to the Processor can be an API call or a bi-directional socket call which can support 65,536 concurrent connections on one server. The following then occurs in steps 1-8 listed below:
1. A Serverless function—a piece of code running on the Processor's backend (i.e., on a Processing Cluster 22)—receives the mobile number 18, PIN 34, item price, Transaction ID, Merchant ID, date and time sent in the Merchant's API request.
2. It computes the OTPIN key using the mobile number 18, 10 secret numbers loaded into memory on start up, and a secret algorithm. The secret numbers are used to generate the unique key for each phone number. This way any Serverless function can validate a PIN without a database lookup.
3. It extracts the OTPIN 36 and item price from the PIN 34 by calling the inverse of the Mixing function with the PIN 34 and OTPIN Key.
4. It then performs the following tasks simultaneously: a) Checks that the item price in the merchant request matches the micropayment amount extracted from the PIN 34. If not, either the merchant submitted an amount different from the listed item price, or the user entered a wrong item price in generating the PIN 34. In either case, the transaction is denied. This verification of price is completed in milliseconds, entails little cost, does not require a database lookup, and can be performed independently by millions of serverless functions; b) Confirms the OTPIN 36 has not expired. It does this using a library which takes the OTPIN 36, and phone number 18 as input and outputs whether the PIN 34 has expired. The OTPIN 36 is created by encrypting current time using a unique key, which in this case is derived from the phone number 18. The process is reversed by generating the OTPIN key from the phone number 18 and using that key to decrypt the PIN 34, and to check that the OTPIN 36 has not expired. This is first-level validation; the Serverless function, validates the PIN 34 and confirms price simultaneously. This takes less than 15 milliseconds and does not require database access. If it is successful, the Serverless function then calls an internal API of the Processor to further validate and record the transaction and respond to the merchant with transaction approval or denial.
5. A call to an internal API of the Processor by the Serverless function constitutes second-level validation. An internal software process then does the following: a) Checks that the phone number 18 and PIN 34 pair received from the merchant are in the local database. This confirms that the phone number 18 and PIN 34 pair was “funded”. i.e., the funds associated with that PIN 34 have been taken from the user's account. This occurred when the PIN 34 was written to the backend by the user's mobile app 30. The user cannot generate a PIN 34 for a micropayment transaction unless the PIN 34 amount is first written to the Processor's backend and the associated micropayment amount is debited from the user's mobile account 34 balance. So, the Processor checks for the phone number 18 and PIN 34 pair in its database PIN Table. This check is a database read. If the phone number 18 and PIN 34 pair is not in the PIN Table, it was not generated by the user, the transaction is fraudulent and is denied. If the phone number 18 and PIN 34 are present it means that the PIN 34 was generated by a legitimate user and was funded; b) The process then writes the merchant ID, item ID, Transaction ID, Date and an Approval Number into that phone number 18 and PIN 34 record and returns that Approval Number to the calling function. If an Approval Number is already present in the record, it means that the phone number 18 and PIN 34 pair has been submitted before. This is double spending, and the transaction is rejected; c) Rejected transactions return a rejection code to the calling Serverless function which returns it to the merchant.
6. If both first and second level payment validations succeed it means the following: a) The OTPIN 36 extracted from the PIN 34 has not expired; b) The micropayment amount extracted from the PIN 34 matches the amount (i.e., the item price) received from the merchant API call; c) The PIN 34 was generated on the mobile device having the phone number 18 received in the merchant call. Only that device could have written that PIN 34 to the backend database before displaying it to the user; d) The payment amount has already been taken from the user's mobile account 34, i.e., the transaction has been funded, so the funds are available; e) The PIN 34 and phone number 18 pair have not been submitted before.

These validation steps can be completed for one transaction in under 100 ms. Thereafter, the original PIN record in the PIN Table of the Processor's database is updated. Updates use a row lock and so support multi-record updates on one database. It also means that simultaneous transactions cannot be performed with the same phone number 18 and PIN 34 pair but must occur serially: The first process locks the record and updates the record and the second process fails since the record will have an Approval Number from the first update.
7. The Serverless function receives the Approval Number for approved transactions which it then transmits to the merchant, who can then release the goods purchased.
8. The merchant is not credited for the transaction but later submits a file of approved transactions which include the phone number 18, PIN 34, item price, item ID, merchant ID, transaction ID and Approval Number. The Processor loads this file into a table, does an inner join with the PIN Table on merchant ID, Approval Number, amount, phone number 18 and PIN 34. It extracts all the matching merchant transactions, sums the transaction amounts less the Processor fees and writes this into the merchant's ledger account, a database table. It also writes the output of the inner join into the merchant's transaction history so the merchant can see individual approved transactions. This update of the merchant's account is very fast—an update of 10 million records can be completed in under 10 seconds—and can be performed multiple times a day.

The time from merchant call to the Processor's response should be under 50 ms if first level validation fails (i.e., OTPIN 36 has expired or PIN 34-encoded micropayment amount does not equal item price); under 100 ms if second level validation fails (i.e., PIN 34 was not generated on device 12 with the submitted phone number 18, or PIN 34 has been submitted before, and under 500 ms if both first and second level validation succeed. With these processing times, costs per transaction should be in the range 0.001¢ to 1¢.

Noticeable elements of this disclosure of system 10 for processing micropayments and/or method 100 for processing micropayments are that the user need not enter personal information to pay, just his phone number 18 and PIN 34 generated by app 30. This eliminates all fraud associated with theft of personal data; the user cannot disavow a transaction as it must be initiated on his device 12 with his credentials; and the merchant cannot commit price fraud as the transaction price submitted must match the amount encoded in the PIN 34. This means that merchants can be signed up without credit checks, as they cannot steal a user's personal information or commit price fraud. For multiple purchases on a website, the user can check a box to save her phone number 18. Subsequently, purchases require only entry of a PIN 34.

### OTPIN Key Generation

The PIN 34 is an encoding of a One-Time PIN (OTPIN) with a micropayment amount on the user's device using a Mixing Function. The PIN 34 is first written to the Processor's backend which must give approval before it is displayed to the user, and a new PIN 34 is required for every payment transaction. The PIN 34 eliminates most types of payments fraud as users do not have to enter a credit card number or personal information. User transactions also require physical possession of their mobile device 12 which is linked to their mobile account 34.

The mobile device app 30 generates PIN 34 using a key derived from the user's mobile phone number 18. This is the OTPIN key received from the Processor's backend server during user registration. The Processor generates a unique OTPIN key for each phone number as follows.

The Processor generates and stores ten UNIQUE fixed length random numbers each of which is mapped to the numbers 0-9. For example: Random Number “a”=8569716626 for 0; Random Number “b”=1006608943 for 1; Random Number “c”=8320410191 for 2; Random Number “d”=9378168969 for 3; Random Number “e”=3445420108 for 4; Random Number “f”=9037230989 for 5; Random Number “g”=3152476698 for 6; Random Number “h”=5580143321 for 7; Random Number “i”=1348767827 for 8; and Random Number “j”=4442322206 for 9.

The OTPIN 36 for any given phone number is generated by concatenating the random numbers to match the phone number 18. This is the same as substituting each number in the phone number 18 with the equivalent random number. The Processor may perform additional transformations in addition to concatenation to generate the OTPIN key. The Processor may also generate the OTPIN key with some or not all the digits in the phone number 18. For example, if the key is generated form the last 6 digits of the user's phone number 18, then OTPIN key for the phone number 908-123-4567 would be derived by replacing the last 6 digits of the phone number 18 with the equivalent random numbers: that is map “2” “3” “4” “5”, “6”, “7”, of the phone number to “random number “c”+random number “d”+random number “e”+random number “f”+random number “g”+random number “h” which gives “cdefgh” or the number: 832041019193781689693445420108903723098931524766985580143321.

This may be the OTPIN key and this method of key generation ensures that the OTPIN key is unique for every phone number 18, since phone numbers are unique. Obviously using all the numbers of phone number 18 to generate a longer OTPIN key is more secure. The random numbers will ideally be stored in a Hardware Security Module, and fresh random numbers will need to be generated at intervals for greater security. Both the random numbers and the algorithm for generating the OTPIN key are known only to the Payment Processor and not to the mobile app 30.

Concatenating random numbers to match phone number 18 is simply an illustrative algorithm. Hashes, or other sophisticated methods can be used to derive a key from phone number 18 using the random numbers as seeds. If using a hash, it is important to avoid hash collisions. Whatever algorithm is used for generating the OTPIN key can be captured in a library and loaded by a Serverless function on program startup.

### PIN and OTPIN Generation

The One Time PIN (OTPIN) 36 may be generated using a Time-based One-Time Password (TOTP) Algorithm that computes a one-time password, the OTPIN 36, using a shared secret key and current time. The shared secret key in this case, is the OTPIN key whose generation is described above. TOTP has been adopted by the Internet Engineering Task Force (IETF) and is described in RFC 4226 and 6238. TOTP is an example of a Hash-based Message Authentication Code (HMAC) which combines a secret key with the current time stamp using a cryptographic hash function to generate a one-time password. The timestamp typically increases in 30-second intervals, so passwords generated close together in time from the same secret key will be equal. The time interval can be arbitrarily increased to generate a long-lived OTPIN.

The TOTP algorithm is well understood and has been implemented in many accessible libraries including Google® Authenticator. A TOTP library is part of the mobile device app 30. The PIN 34 may be a combination of the OTPIN 36 and the micropayment amount which the user wishes to pay. PIN generation occurs as follows:
1) The Processor generates an OTPIN key as described above which is the shared secret key for OTPIN generation. The Processor may set a date when new random numbers have to be generated. This means that the OTPIN key will change after this date. This is a security step.
2) The mobile device app 30, following user sign up, calls the Processor and downloads a library with the OTPIN key for that specific mobile device phone number 18.
3) To generate PIN 34, the user clicks “Generate PIN” and enters the payment amount i.e., the item price, on her device app menu. The device app 30 then uses the downloaded OTPIN key, the current time and its local TOTP library to generate OTPIN 36. OTPIN 36 is created by adding the expiration interval to the current time before hashing (encryption). This simplifies validation since the expiration interval need not be known to validate the OTPIN 36, instead the expiration time obtained from decryption has to be in the future for a valid OTPIN 36; if it is in the past, the OTPIN 36 has expired. (Validation of OTPIN 36 input uses standard methods for generating one-time PIN 34 as described in RFC 4226 and RFC 6238). For example, OTPIN 36 created at 11:59:00 with an expiration interval of 60 seconds, will have an expiration time of 12:00:00. If it is decrypted at 11:59:30, its expiration time of 12:00:00 means it is still valid. However, if it is decrypted at 12:01:00, its expiration time of 12:00:00 will be in the past which means PIN 34 has expired.
4) The mobile app 30 then combines the OTPIN 36 with the micropayment amount by running it through a function—the Mixing function—and then encrypts the output with the OTPIN key to output PIN 34. This is the PIN 34 that is used to make a micropayment. This process of mixing the expiration time with the payment amount can be as simple as adding the payment amount to the OTPIN 36, and then encrypting the SUM with the OTPIN key to output the PIN 34. The steps are: Function (Current time+time interval to expiration+key)=OTPIN 36; Encrypt with OTPIN Key [Mixing Function (OTPIN 36+the payment amount or item price)]=PIN 34; The PIN expiration time is the OTPIN expiration and can be made arbitrarily long (e.g., 7 days) to get a long-lived PIN 34.
5) The PIN 34, when it is created, is not immediately displayed to the user, instead the mobile app 30 subtracts the PIN item price from the user's balance (held on the device as well as at the Processor), writes the PIN 34 with the phone number 18 and item price to the Processor in an API call. The Processor receives the phone number 18 and PIN 34, debits the user's mobile account 34 by the item price, writes the phone number 18, PIN 34, and amount into a PIN Table in its database and then returns confirmation to the user's mobile app 30 authorizing display of PIN 34. The mobile app 30 then displays the PIN 34 to the user along with a counter that shows the user time remaining for the PIN 34 to expire, (e.g., a 30 second counter). The PIN 34 expires when its OTPIN 36 component expires. Because the funds associated with the PIN 34 have already been debited from the user's account, the phone number 18 and PIN 34 pair is now currency. The PIN expiration time can be made very long e.g., 7 days to get a “Long-lived” PIN 34. Long-lived PINs can be used for payment where the user's mobile app 30 does NOT have access to the Processor but the merchant does e.g., in an underground subway without internet access, but where the merchant payment terminal can make calls to the Payment Processor.
6) The Processor periodically checks the PIN Table in its database for PINs that expired unused. It reverses the debit to the user's account for such PINs and sends an account update call, with the new balance, to the mobile device 12 linked to that account. The mobile app 30 then updates the local balance which is displayed to the user.
7) The user submits the PIN 34 generated on her device 12 along with her phone number 18 to the merchant. This can be by entering manually into the merchant's website, by transmitting it wirelessly to the merchant's POS terminal located at the merchant's physical location, by transmitting it to a POS terminal provisioned for the merchant by the processor in a remote location, or by transmitting it to a remote device designated by the merchant. So, the merchant has a variety of interfaces over which to receive the user's PIN 34 and phone number 18 as payment. 8) Once it is used, a PIN 34 cannot be reused; a new PIN 34 has to be created and submitted with the device phone number 18 for subsequent transactions.

This process described above is generally shown in FIG. 2.

### Transaction Approval

After the user generates the PIN 34, the phone number 18 and PIN 34 pair is now currency and can be used for payment not just at a website but can be transmitted to the merchant over any channel: wirelessly, by manual entry, by Bluetooth®, by a near-field communication chip, by transmitting a QR code, by reading a QR code identifying the merchant, to which the PIN 34 and phone number 18 pair are added and then submitted to the merchant. The merchant then follows steps to obtain payment approval. These steps are outlined below:
1) When the merchant receives the phone number 18 and PIN 34 as payment for the item the user wishes to purchase, he sends both plus the item price, his merchant ID, and a transaction ID (that identifies the transaction) to the micropayment processor via a network call. The call to the microprocessor can be an API call or a bidirectional socket call which can support 65,536 concurrent connections on one host.
2) The micropayment Processor receives the data from the merchant, computes the OTPIN key from the phone number 18, decrypts and decomposes the PIN 34, by passing it through the inverse of the Mixing function, confirms that the OTPIN 36 has not expired and that the amount it contains matches the price submitted by the merchant. Non-matching item prices mean either the merchant or the user provided an incorrect item price and the transaction is declined. In one embodiment, the transaction may be approved if the item prices do not match, provided that the price submitted by the merchant is less than the item price in the PIN 34. The price difference is credited back to the user by the Processor. This is ideal for Long-Lived PINs 34 so that the user does not have to enter an exact amount in generating PIN 34.
3) The Processor then checks the PIN Table in its database for this phone number 18 and PIN pair 34. If the pair is in the database, this confirms that the PIN 34 was created legitimately and its amount was already debited from the user. The Processor then generates an Approval Number and updates that record in the PIN Table record with the merchant's ID, Approval Number, item ID, transaction ID, date and time and returns the Approval Number to the merchant. It does not credit the merchant's account at this time in order to increase speed and reduce processing overhead. The merchant will later submit a list of approved transactions to receive a credit to his account.
4) The merchant on receiving the Approval Number releases the item purchased to the user. The merchant's account is not immediately credited with approved transactions. Crediting the merchant's account is performed in a separate step: The merchant will periodically submit a batch of approved transactions with PINs 34, phone numbers 18 and Approval Numbers to the Processor. The Processor checks these transactions against the PIN Table in its database, extracts the valid transactions by doing an inner join between both Tables, and then credits the merchant with sum of all the approved transactions, less the Processor's transaction fees.
5) The approved transactions are written to the merchant's account. The merchant can log into his account and immediately see the transactions credited to his account.

### Additional Security Features

The disclosure offers two additional security features: If mobile device 12 is lost or stolen, the user can remotely “lock” or “unload” the funds on the phone. This is because funds are not actually “on” the phone but in a bank account. A database table entry links the mobile device phone number 18 and phone ID to the bank account. Removing the link, means the bank account can no longer be accessed from that phone 12, though the funds and bank account are unaffected. This provides increased transaction security for mobile transacting.

Problems Solved by this Invention

The preceding description shows how the invention solves the 7 key challenges for processing micropayments, as discussed below:
1) Keeps cost per transaction below the micropayment amount. The merchant makes a call to the processor who does a database look up, updates a single record and returns an Approval Number. PIN decryption, decomposition, and validation is performed with an OTPIN key derived from the phone number 18 and can be performed by any process that has loaded the random numbers with which to generate an OTPIN key from the phone number 18. Total transaction processing time is measured in milliseconds. Processing costs per transaction can be as low 0.001 cents.
2) Enables processing of very large payment volumes without raising per transaction costs. The processing cost for each transaction has 2 components: The cost of decrypting the PIN 34 and the cost of updating a record in the Processor database with a merchant ID, Approval number, and transaction details. Both can be performed in under 500 milliseconds for very large transaction volumes without increasing cost per transaction. The cost of the merchant network transmission to the Processor is over the internet and is partly borne by the merchant via its network 20 or data plan.
3) Is real time. The micropayment transaction amount is taken from the user's account when PIN 34 is generated, so once the merchant receives approval, he knows funds are good and can then deliver the service. This is because the Processor only sends approval after confirming that the phone number 18 and PIN 34 pair from the merchant is in its PIN Table, meaning it is backed by funds. This is like paying a merchant for a purchase with a bank check; the merchant contacts the bank to ask if the bank check is good, receives a “Yes” and can immediately release goods purchased, since a good bank check represents guaranteed funds. The “Yes” in this example is equivalent to receiving an Approval Number from the Processor in this disclosure. This Approval Number, Merchant ID, item ID, date and time are written into the PIN Table in the Processor's database before the Approval Number is transmitted to the merchant. The Approval Number is later used to validate transactions and credit the merchant's account for transactions periodically submitted by the merchant in a batch file.
4) Removes the need to provision redundant infrastructure to handle peaks. Processing Cluster 22 in this disclosure grows and shrinks dynamically to match changing transaction volumes—a process called autoscaling, available from most cloud provides for servers, but described in this invention for databases. Since these infrastructure services are priced by Cloud providers in hourly, second or millisecond increments, and infrastructure dynamically tracks transaction volume, it eliminates the need to provision redundant infrastructure to accommodate peaks and enables accurate prediction of per transaction costs.
5) Provides robust security, and removes the use of personal information. Use of the phone number 18 and PIN 34 unequivocally identify the user and the item price, while preventing double spending.
6) Minimizes processing time for each transaction regardless of merchant location.
7) Runs on the internet and does not require a private network.
8) Requires only 3 parties: a buyer, a seller, and a processor. This is reduced to 2 parties if either the buyer or the seller is also a processor.
9) Authenticates the user for each payment transaction for both online and offline payments.

### Other Aspects

This disclosure of system 10 for processing micropayments and method 100 for processing micropayments uses several features to minimize per transaction processing costs namely: 1) Database Federation; 2) Automatic splitting or merging of Processing Cluster 22 in response to load; 3) Serverless functions.

Automatic splitting of Processing Cluster 22 requires database federation and a method to identify the Processing Cluster 22 that holds a user's record represented by his device phone number 18. Serverless Functions run on the hardware of a third party and billing is based on how long the Serverless function runs for. By removing the need to purchase, stack, rack and provision server hardware, Serverless functions significantly reduce processing costs.

### Database Federation

A single monolithic relational database does not scale well. As records and processing needs grow, the only way to maintain performance is often to scale vertically by switching to a bigger server with more CPU, memory and disk, called a “forklift upgrade”. This is expensive and eventually reaches a ceiling, beyond which no further scaling is possible. Some relational databases, like Oracle RAC, and NoSQL databases support scaling horizontally by adding nodes, but they are either very expensive or do not have data consistency across nodes—critical for payment processing—and are therefore unsuitable for micropayments.

This disclosure uses database federation with a shared-nothing architecture to provide distributed database processing, horizontal scaling, and fast read/write operations, all vital for micropayment processing. Federation means that the database is split into many database nodes, each database node holds a specified range of user records. Database federation provides several benefits:
1) Faster queries. Smaller amounts of data in each federated node, compared to a single monolithic database, translate into much faster read/write operations, and allow for low-cost nodes with smaller CPU, memory and disk. Also, failure of a node is limited to records on that node.
2) High availability. The database node is the active node in an active/passive, high availability database cluster with data synchronously written to the passive node. This provides for data recovery in case of failure of the active node.
3) Concurrent Database Processing. Each database node belongs to an autonomous, Processing Cluster 22 having its own application tier—which may be servers, virtual servers, or Containers behind an Elastic Load balancer with Automatic scaling, etc. Transactions for all user records on a database node are processed entirely within its Processing Cluster 22. So, federation allows writes to be performed in parallel to different database nodes on different Processing Clusters 22 which vastly increases throughput while minimizing cost.

The federated database nodes are NOT queried as a single database, instead each payment request is routed, via a phone number-to-Processing Cluster name resolution scheme, to the specific Processing Cluster 22 with the database node that holds the required user record. Each Processing Cluster 22 will have a target transaction volume at which it can keep per transaction costs below a specific amount e.g., 1,000 transactions per second at which processing costs remain under 1¢ per transaction. Above this transaction volume per transaction costs will rise above the specified threshold. To prevent this cost increase, if performance metrics in a federated database node persistently exceeds a given value, which is equivalent to a given volume threshold, a separate Processing Cluster 22 is automatically created with a new database node that contains half of the most frequently accessed records from the original database in the original Processing Cluster 22.

Database Federation with user record location via a phone number-to-Cluster name resolution service is used to ensure that the database does not become a bottleneck, can scale up to meet demand, and that each user payment transaction is routed to the Processing Cluster 22 with the specific federated database that holds that user's records. Database federation in this invention uses a “shared-nothing” architecture where each database has its own set of user records. The services, infrastructure, and software required for processing payments for those users are attached to the database and all form a processing unit called a Processing Cluster (Cluster) 22. The federated databases are not partitions of a larger database which can be queried as a unit. Instead, each is independent and can only process payments for user records in its own database. A Processing Cluster 22 can hold millions of user and merchant records and does the following:
A) It receives API calls from a mobile device app 30 or from a merchant to process a user payment or update a user record, e.g., a user writing a PIN 34 or a merchant submitting a user payment transaction. Each call is routed to the Processing Cluster 22 with the federated database that holds the records for that specific user. This database includes the Tables which hold PIN 34 and phone number 18 pairs, completed transactions, user balances, user registration data, user bank account data etc.
B) The appropriate Processing Cluster is identified as follows: The API calls to the Processor is over HTTPS for security, and require an Access Token (hereinafter Token) to authenticate and authorize the caller. The mobile device app 30 first calls a phone number-to-Cluster service with a phone number in order to get a Token with which to make API calls to the Processing Cluster 22 that holds that user's records. It also receives the Cluster 22 name to call. The Token expires after a fixed time interval (e.g., one hour) and the Token service must be called again to renew it before an API call can be made. Using a Token to authenticate and authorize API calls is well understood. The phone number-to-cluster name Service returns a Token AND the Fully Qualified Domain Name (FQDN) of the Processing Cluster 22 that holds the records for the phone number 18 provided by the caller. The caller does not know the Processing Cluster 22 where that phone number record resides. The phone number-to-Cluster Name service (described below) acts like a recursive Domain Name Server (DNS) but instead of returning an IP Address may return the Fully Qualified Domain Name (FQDN) and the IP Address (or IP addresses) of the Processing Cluster 22 along with a Token with which to access it. It may also return just the FQDN of the Processing Cluster 22, which can then be resolved by regular DNS to get the IP address or addresses of the Processing Cluster 22.
C) Merchant records for each registered merchant also reside in a Processing Cluster 22. The Processor can call the phone number-to-Cluster name service with a merchant ID, assigned by the Payment Processor, and formatted like a phone number, in order to get the Name of the Processing Cluster 22 that holds the merchant's records and a Token with which to call that Cluster 22.
D) During payment processing all transactions are written only to the user's Processing Cluster 22. Periodically, a process on each Processing Cluster 22 reads the PIN table and extracts the records for individual merchants by merchant ID, and writes them into a temporary table. At intervals this table is uploaded to the “home” Cluster 22 of the merchant i.e., the Processing Cluster 22 that holds that merchant's records. This is required only if user and merchant records are on different Processing Clusters 22. It means that users, but not merchants, see their transactions and balances in real time since all of the user's payment transactions are saved on his home Processing Cluster 22 which updates the user mobile app 30 in real time. Merchant transactions and balances on the other hand, may be distributed across multiple Processing Clusters 22 in temporary tables that hold the payment records of any users who paid that merchant. These merchant transactions are uploaded at intervals from a temporary table in those Clusters 22 to the Processing Cluster 22 that holds that merchant's permanent records.
E) Although transaction records for user and merchants may be in different federated databases, their bank accounts are co-located in the same bank. This could be a partner bank if the Payment Processor is not a bank, or the payment Processor itself if it is a bank as well as a Processor. The federated databases which hold the user and merchant balances and histories are distinct from the bank account balances for each user and merchant. Both are reconciled at intervals. Immediate reconciliation is triggered whenever a user or merchant moves cash form his mobile account 34 at the Processor's bank to another bank. So, the Processing Clusters 22 with federated databases capture the payment transactions and balances, which are then used at intervals to update actual cash balances in the user and merchant bank accounts which reside in the same bank. Funds movements within accounts in the same bank have little or no cost to the Payment Processor as they are simply book keeping entries in the books of the bank.
F) Processing Clusters 22 are designed so that per transaction processing costs are below one cent. As processing load increases, per transaction costs rise and above a specific volume threshold will exceed one cent. At this volume ceiling, the Processing Cluster node which has one federated database but may have many processing nodes, splits into 2 in order to keep per transaction costs below one cent. The new or “daughter” Cluster 22 has half of the most recently active records from the old or “Mother” Cluster 22. This has the effect of significantly reducing the load on the Mother Cluster without requiring duplication of the entire database.

### Automatic Splitting of a Processing Cluster 22 in Response to Load

As requests to a Processing Cluster 22 increase, the application nodes that receive the requests—which can be servers, virtual servers, or containers—automatically increase in number (scaling out) and when requests drop, the number of nodes decrease in number (scaling in). This is generally referred to as autoscaling, is well understood, and occurs within a Processing Cluster

Splitting and merging a Processing Cluster 22 in this invention goes beyond scaling out and scaling in of the application nodes but involves a database that splits and merges dynamically to handle peak transaction volumes. Each Processing Cluster 22 can process transactions at a marginal cost which is below a minimum threshold e.g., 1 c. As total transaction volume increases, application nodes increase in number, but beyond a certain point, the database node of the cluster 22 becomes a bottleneck, marginal cost per transaction begins to rise. When marginal cost hits a specified transaction threshold, as captured in a database metric, the single Processing Cluster 22 automatically splits into two, with the new Cluster 22 now processing requests for half of the most active records in the Original or Parent Cluster 22. When the number of transaction requests fall, some or all of the new Cluster records are copied back to the old Cluster 22. If all the clusters 22 are copied back then the new Cluster 22 is removed.

If requests to the old cluster 22, instead of falling, keep increasing, additional active records are moved from the old to the new Processing Cluster 22. If either Cluster 22 hits a volume threshold—tracked via database performance metrics—it splits into a third Processing Cluster 22. As transaction requests fall, the records in the newest cluster 22 are copied (synced) back to its “parent” Cluster 22. As transaction requests fall, Clusters 22 are removed in reverse order beginning with the newest. This process of automatic splitting and merging removes the need to provision each Processing Cluster 22 with a large capacity database with redundant capacity to handle peak volumes. Instead, like the autoscaling application nodes, the database can scale out and scale in back to a base level on hitting specified database metrics.

This automatic splitting of a Processing Cluster 22 ensures that as volume increases, marginal processing cost per transaction never exceeds the specified amount and query time does not rise. For example, a Processing Cluster 22 may start with two application nodes and a database, and then scale up to process 1,000 micropayment transactions per second, (i.e., 86.4 million transactions a day) at per transaction costs below 1¢. If above this volume, per transaction costs rise above 1 c, a new Processing Cluster 22 is automatically created from the existing one, by splitting its database into two and creating two new application nodes for this database. The new database takes half the most recently active unique records from the old database. The two new application nodes and the new database are behind a new load balancer and are a new Processing Cluster 22 which receives requests for records in its database. This keeps per transaction processing costs below a specified threshold. The trigger for splitting the Processing Cluster 22 is one or more database performance metric used as a proxy for high processing volume. Example metrics are throughput (number of queries), latency (response time per query), connections (number of processes connected to the database), replication or number of locks.

### Database Splitting

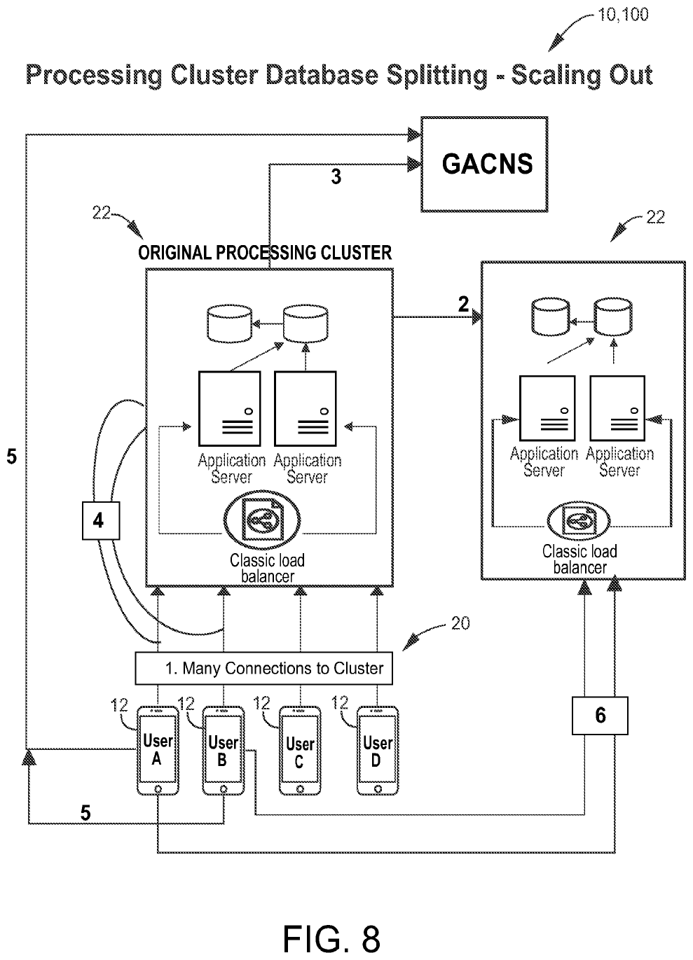

As shown in FIG. 8, processing Clusters 22 use a federated “share-nothing” database which means that each Cluster 22 has its own set of user and merchant records in its database. Transactions involving a user or merchant in that database must call that Processing Cluster 22. When there is heavy load on the database, the Cluster automatically splits into two. Splitting occurs as follows:
1) The database is split into two databases. A new set of application nodes is spun up which are connected to the new database. Both nodes and database are placed behind a new load balancer. At this point this is a new Processing Cluster 22, its databases have the same schema as the parent database, but have no records. The new Processing Cluster 22 is NOT receiving any requests.
2) A log monitoring process now syncs half of the most recently accessed records from the old to the new database. The objective is to split the actively accessed records, i.e., phone numbers 18, into two and move half to the database of the new Cluster 22 where it will be processed independently. To do this, the last 1,000 updated UNIQUE records are extracted, ordered numerically and then the odd numbered records within them are synced to the new Cluster 22. Syncing is a process that actively replicates selected records in the old cluster 22 to the new one. At this point each write on the selected (odd numbered) record is replicated to the new database in the new Cluster 22.
3) All transactions for these odd numbered records (which are phones numbers 18) are being written to the old cluster 22 but replicated to the new one. A configuration change will then be made, which is captured by the phone number-to-Cluster service so that new requests go to the new Cluster 22.
4) Both merchant and user route requests to the user's Processing Cluster 22 by first calling a Phone Number-to-Cluster Service. This service when called with a phone number 18 returns an access Token AND the Fully Qualified Domain Name (FQDN) of the Processing Cluster 22 where that phone number 18 record resides. When called with the FQDN of a Cluster 22, the service returns an access Token AND all the phone records in that Cluster 22 (this call can only be made by an administrator). The access Token authorizes the user or merchant to call the Processing Cluster 22. Without the Token, the caller's request is ignored. The Token also has an expiration time, but can be forced to expire by the Cluster 22. The caller will then have to call the phone number-to-Cluster service to get a new Token with the Cluster Name to the user's record. Each Cluster Name returned by the Phone Number-to-Cluster service has a Time-To-Live (TTL) which determines how long that name response can be cached before a fresh call to the Service is required. This value can be set to a default for all records or set for individual records. It can be between 0 seconds and a larger number (e.g., 900 seconds), where 0 seconds means the caller cannot cache the response but must call the service each time to get the Cluster Name, and 900 seconds means the result of each call can be cached for 15 minutes. So, if a batch of phone numbers 18 is updated to point to a new Processing Cluster Name, then after 15 minutes, any calls to the phone number-to-cluster name service will return the new cluster name, so transactions on the updated phone numbers 18 will go to the new Processing Cluster 22. The internet Domain Name Service (DNS) is similar to the phone number-to-cluster service, has an identical hierarchy and also includes a time-to-live for each response, but differs in that DNS when given a Fully Qualified Domain name returns an IP address and does not return a Token. A Processing Cluster 22 can call the phone number-to-Cluster service to update its records, i.e., add new phone records that point to itself or replace its FQDN with that of a different Cluster 22 for records it previously held, or create a new entry.
5) The Cluster monitoring process calls the phone number-to-Cluster service and updates selected (Odd numbered) records to point to the New Processing Cluster 22. It sets the time-to-live to 0 for these records. It then invalidates the Tokens for all connections for the selected records and kills their connection to the database. This has the immediate effect of reducing the load on the database. Since half of all active transactions are temporarily disconnected.
6) The specific callers automatically attempt to reconnect and get the message “Token expired”. They each then call the phone number-to-Cluster service with a phone number to get a new Token and the name of the New Processing Cluster 22. They then call the New Processing Cluster 22. After a brief interval, the monitoring process resets the TTL for the records now residing on the New Processing Cluster 22 to the default (e.g., 15 minutes).
7) Requests are now evenly distributed between the old Processing Cluster 22 and the new one. The result is that by moving a percentage of the most actively accessed records in a Cluster 22 into a new cluster 22, load is distributed move evenly between an old Cluster 22 and a new one, and marginal processing costs do not rise above a specified threshold.
8) If load continues to increase, additional records are identified, synced to the new cluster 22 from the old one, the phone number-to-cluster services is again updated with these new records, the TTL is set to 0, the Tokens to those callers are invalidated and their database connections to the old Cluster 22 terminated.
9) If transaction volume continues to rise, automatic splitting of either the new or the old database occurs—depending on which has the higher database metric—and a third Processing Cluster 22 is created.
10) Conversely, if database load falls, the process is reversed. The phone number-to-Processing Cluster Service is updated, so that all the phone records on the new Cluster 22 are changed to point to the old Cluster 22, the TTL of the records are set to 0, the Tokens for those callers connected to the new Cluster 22 are invalidated, and their database connections are killed. They will then need to call the phone number-to-phone service to get new Tokens and the Cluster name for the user's phone number 18 which will once again point to the old Cluster 22. This reverse process does not have to be performed for all the records in the new cluster 22, but can be done for 50% (or some other percentage) of the most recently active records. If it is performed for all the cluster records, the new Processing Cluster 22—nodes and database—is deleted after its records are synced with the old Cluster 22.

So, when transaction volumes fall, CPU utilization also falls, cluster nodes are removed, database utilization metrics drop and new Processing Clusters 22 are removed. This again has the effect of keeping per transaction costs below a specified threshold e.g., 1c. So, Processing Clusters 22 produced from a split can “contract” or “disappear” based on database performance triggers. The trigger for creation of a new Processing Cluster 22 is tied to database performance metrics as opposed to the triggers for scaling out an application node which is tied to CPU, memory, or processing load.

Automatic generation of a new Processing Cluster 22 through database automatic scaling solves the two key cost challenges of micropayments: It keeps costs per transaction below a micropayment ceiling; and allows almost arbitrary increase in processing volume without increasing marginal cost.

### Serverless Function

Serverless computing refers to deploying functions or software programs with a cloud provider for which no server or hardware is provisioned, but which instead run on the cloud infrastructure “invisible” to the Processor. Only two configuration parameters are needed to deploy a serverless function: a) The amount of memory required by the function or program; and b) The event that will trigger the Serverless function to run, which is usually an API call to process a micropayment. Most Cloud providers support serverless functions, written in a variety of languages including Java, Nodejs, Python, Go, C # and Ruby.

Pricing is in millisecond increments and based on run duration of the function and number of calls made to it. Cost per transaction can be accurately quantified based on processing duration of the function and is much lower than the cost of deploying physical or virtual machines. For example, Amazon Web Services® (AWS) offers a serverless function service called Lambda and 1,000. Lambda functions can be run concurrently in one AWS account. Multiple accounts can be used for even greater concurrency. Cost is based on memory allocated, duration of each Lambda function run (calculated in 100 millisecond increments), and number of calls to the function. An AWS Lambda function with 128 MB of memory is priced at $0.000000208375 per 100 milliseconds. A payment processed entirely with such a Lambda function that takes 5 seconds, costs $0.0000104 per transaction.

In this disclosure of system 10 for processing micropayments and/or method 100 for processing micropayments, serverless functions are used for first-level PIN validation i.e., to decompose the PIN 34 into OTPIN 36 and micropayment amount, confirm that the OTPIN 36 has not expired, and that the micropayment amount from the merchant matches that from the PIN 34. This validation does not require reading or writing to a database. If validation is successful, the Serverless function calls an internal API of the Payment Processor for second-level validation. This involves database reads and writes handled by Docker Containers running behind a Load Balancer. A Docker container image is a lightweight, standalone, executable package of software that includes everything needed to run an application: code, runtime, system tools, system libraries and settings.

### Phone Number-to-Processing Cluster Name Service

Structure—Phone number-to-Cluster Name Service is a method of identifying the specific Processing Cluster 22 holding the federated database where the user or merchant record resides. Each user record is linked to and accessed through his device phone number 18, stored in the federated database of a specific Processing Cluster 22 identified by a Fully Qualified Domain Name (FQDN) or IP address. The Phone number-to-Cluster Name Service (also called Cluster Name Service) when called with a phone number 18 returns the Processing Cluster Name (FQDN) that holds the records for that mobile device phone number 18. When called with a Processing Cluster Name, it returns all the phone numbers whose records are held in that Processing Cluster 22. The Cluster Name Service uses a structure similar to the Domain Name Service (DNS) where Cluster Name Servers hold records that map each phone number to its Processing Cluster 22. However, instead of resolving an FQDN to an IP address and vice versa as in DNS, the Cluster Name Service resolves a phone number 18 to the Processing Cluster FQDN or IP addresses that holds that phone number record and also returns a token. The Processing Cluster Name returned by the service has a Time-To-Live, representing the maximum time for which that response can be cached by the caller. After that time, the caller must contact the server again to get the FQDN of the Processing Cluster 22 where that record is held. However, because the Cluster Name Service also returns a Token with which to access the target Processing Cluster 22, the Time-To-Live is not strictly necessary, because when the Token expires the caller must contact the Cluster Name Service with a phone number to get a new Token, at which time it may get a new Processing Cluster Name. The Cluster Name Service can return a different Processing Cluster Name during Token Refresh. So, if Token expiration time is less than the TTL of the phone number record, it supersedes the TTL for renewing the Processing Cluster Name, and it forces the caller to refresh its cache with the new name.

The phone number to Processing Cluster mapping is held on Cluster Name Servers. Since the actual Processing Cluster 22 that holds the phone records has a random mix of phone numbers 18, Cluster Name Servers are needed to efficiently determine on which Processing Cluster the records of a phone number 18 are held. Processing Clusters 22 can update records in the Cluster Name Servers and can do so either singly or in batches. Cluster Name Server administrators or admin processes can change the Processing Cluster FQDN assigned to any phone number 18 on the Cluster Name Server. The phone number 18 would have to be moved to that Processing Cluster 22 before the update, otherwise the records for that phone number 18 will not be found on the Processing Cluster 22 returned by the Cluster Name Service. Phone number-to-Cluster resolution uses a multi-level hierarchy of Cluster Name Servers to resolve phone numbers 18 to Processing Cluster names across the globe. It works as follows:
1) The first level Cluster Name Servers or Root Servers are the Global Authoritative Cluster Name Servers (GACNS) that hold the 196. Phone Country Codes of all the world's countries plus the name(s) of the Cluster Name Server(s) in each country. The Global Name servers each have all the worlds Phone Country Codes as key to value records, where the key is the country code and the records are one or more Cluster Name Servers for that country, called Country Cluster Name Servers (CCNS). The Country Cluster Name Server in turn contains a list of In-Country Cluster Name Servers (ICCNS) which between them hold the entire phone number space for that country and map each number to a Processing Cluster 22. Each ICCNS holds a unique set of phone numbers 18. So, the Global Authoritative Cluster Name servers have the country codes and the Country Cluster Name Server(s) for each country code. The Country Cluster Name Servers have the Cluster Name Servers inside the country and the range of phone numbers 18 each one has. The In-Country Name Servers (ICCNS) each hold a range of phone numbers 18 each of which is mapped to the specific Processing Cluster 22 that holds its records.
3) The phone numbers 18 held by each ICCNS can be allocated either by dividing up the entire phone number space represented by the number of digits in the phone number 18, or by assigning phone numbers 18 to each Cluster Server by area code. The former is more efficient, since parts of the total phone number space are not used. For example, excluding the country code, the United States has a 9-digit phone number which represents 1 billion possible phone numbers. So, if each Cluster Name Server can hold 1 million phone number records, then 1,000 Cluster Name Servers will be required for the United States alone. However, the first 3 digits of a United States phone number, called the area code, are assigned by geography using the North American Numbering Plan. The result is that out of the 1,000 possible digits that can be used as the first 3 digits of a phone number only 346 are in fact used as area codes. That is, the United States has only 346 area codes. This means that the total number of possible 9-digit phone numbers is 346×10⁶ or 346 million, which require only 346 Processing Clusters 22, if each Cluster holds 1 million phone records. Because, most area codes will have less than 1 million active phone numbers, Cluster Name Servers may be assigned phone numbers for multiple area codes.
4) For a country with a small population, the number of phone number records within that country will be small so it can have one Cluster Name Server for the entire country. For example, Anguilla with a population of 13,254 has the area code+1264 followed by a 7-digit number. If each inhabitant had 4 unique phone numbers 18, the total number of phone records would still be under 60,000. All phone to Processing Cluster records can be held on one Processing Cluster 22. In fact, the whole country can have One Processing Cluster 22, that holds all phone number records. The Country Cluster Name Server will point to an In-Country Cluster Name Server whose records map all phone numbers in the country to the same Processing Cluster.

If the country has a large population, it will have more digits in its phone number 18 to accommodate the larger population, more In-Country Cluster Name Servers, and more actual Processing Clusters 22. The total phone number space will have to be divided across many In-Country Cluster Name Servers (ICCNS) each of which holds a portion of the total phone number space of the country, which may be allocated by area code. For example, the United States has a population of 350 million, country code of +1, and a 9-digit phone number with area codes assigned by state: New York with a population of about 19 million, in 2019, has 19 area codes. This can be assigned to 19 Cluster Name Servers if each Cluster 22 holds 1 million records. Since some area codes will have much less than 1 million active phone numbers, some In-Country Cluster Name Servers can hold phone records for multiple area codes.

### Phone Number to Processing Cluster Name Resolution: How it Works

The Phone number-to-Cluster Name service on receiving a phone number calls the Global Authoritative Cluster Name Server (GACNS). The GACNS users the country code to call the Country Cluster Name Server (CCNS) with the phone number 18. The CCNS then calls the In-Country Cluster Name Server (ICCNS) that has all numbers that begin with that area code. That ICCNS in turn returns the Fully Qualified Domain Name (FQDN) and IP address of the Processing Cluster 22 that holds that phone number 18, to the CCNS, which in turn returns it to the GCNS who can then generate a Token for calling that Processing Cluster 22. It then returns the Token with the Processing Cluster FQDN to the caller. The CCNS can store the ICCNS as key values. For example, with Costa Rica which has the country code 506 and two area codes (also called city codes) of 001 and 054 the names for the In-Country Name Servers can begin with the city codes, for example, 001.costarica-iccns.com and 054.costarican-iccns.com. When either of these In-Country Clusters Servers receive a phone number it searches its records and returns the Fully Qualified Domain Name (FQDN) of the Processing Cluster 22 that holds that record with a Token. This is either passed directly to the caller or passed up through the CCNS, to the GACNS to the caller.

The caller receives the Processing Cluster FQDN, and if the response does not include an IP address, it can then call a conventional DNS server with that FQDN to get the IP address of the Processing Cluster 22. Since a Processing Cluster 22 can have multiple IP addresses, and DNS infrastructure already exists to resolve FQDNs, the phone number-to-Processing Cluster Service may choose to only return FQDNs.

The records in each Cluster Name Server can be dynamically updated, provided the updater has the right security access.

### Cloud Technologies Used

The disclosed system 10 for processing micropayments and/or the disclosed method 100 for processing micropayments may use automatic scaling of the application nodes and automatic generation of a new Processing Cluster 22 to keep per transaction costs below a specified threshold; this is crucial for micropayments. Two other cloud technologies are used to improve performance. Docker Containers, and Content Delivery Networks.

Docket Container—A Docker Container is a software unit within which code and all its dependencies is packaged, so the application starts and stops quickly, and runs reliably from one computing environment to another. Many Containers can run on the same machine, with each running as an isolated process in user space, though they each share the Operating System kernel with other Containers. Containers enable much better utilization of the compute, memory, networking and storage resources and are also offered by Cloud Providers as a serverless service. In a Processing Cluster 22, automatic scaling is applied to Containers instead of to physical servers or virtual machines. Because Containers can stop or start in under a second, scale out and scale in is extremely fast, and tightly track increases or decreases in payment processing requests; it eliminates resource redundancy and so keeps per transaction costs low.

Containers are used for second level transaction validation which require database reads and writes. Payment requests received from the first-level Serverless processes that validates the PIN 34 are sent to a load balancer which distributes requests in a round robin fashion to Containers within the Processing Cluster 22. Validated transactions are written to a database and an Approval Code generated and returned to the calling merchant.

Content Delivery Networks—Although, Serverless functions can run within the Processing Cluster 22, they can be deployed via a Content Delivery Network (CDN). A CDN is a geographically distributed group of servers, provided by a third party, that work together to provide fast delivery of Internet content. The first time a piece of content or code is requested, it is retrieved from the origin server where it resides, served to the requester, and then cached in the CDN server nearest to that requester. Subsequent requests for the same content—the Serverless function in this case—is retrieved from the cache, so network round trip time is minimized. Also, the CDN maintains its connection to the origin server, so traffic between cache and origin—e.g., Serverless function calls to the Processing Cluster—are fast, as there is no new TCP connection set-up overhead. The CDN cache also allows the Serverless function to route requests to a different origin e.g., a different Processing Cluster 22, based on the request attributes. A serverless function running in a CDN is offered by most cloud providers. Amazon Web Services (AWS)® provides a Serverless function that runs in an AWS CDN called CloudFront and is called Lambda@Edge. It is priced at $0.00000625125 per second (in 2020) being a combination of CDN and Serverless function (Lambda) pricing plus $0.60 per million requests for a 128 MB memory Serverless function. For 86.4 million requests, where each request is processed in 2,000 ms, this equals $1,132.06 ($1,080.22+$51.84) or a cost of $0.000026205 per transaction confirming that very, very low per transaction costs can be achieved with this disclosure.

### Multiple Bank Co-Location

Merchant and User Account Co-location. A user who downloads the mobile app 30 and signs up with a Processor, and a merchant who registers to accept micropayments, each get a bank account with the Processor's Bank. Co-locating merchant and user accounts within the same bank means there is near-zero network and cost overhead to move funds between accounts. Transactions are captured as entries in the database, so balances and transaction details can be reported in real time by querying the database. Funds in user and merchant bank accounts are reconciled periodically with the Processor's database or whenever a request to move funds is received. Reconciliation simply means updating the Bank's account records of the Processors users and merchants with the Processors database records which are definitive. Funds transfers to other banks is done by the Bank via ACH, FEDWIRE or RTP (Real Time Processing) for a fee.

Multiple Processing Clusters. The Processor may have one or more Processing Clusters 22 with one or more Banks. The options are as follows:
1) If it has only one bank, it may dedicate one Processing Cluster 22 to that bank, so the database records for all its user and merchant accounts in that bank are held on that Cluster 22. It may also have multiple Processing Clusters 22 for that bank. For this, records of its user and merchant accounts are spread across two or more Clusters 22. This is a many-to-one dedicated Processing Cluster 22.
2) It may have one Processing Cluster 22 for two or more banks, so that all the account records of its users and merchants across all the banks are held in One Processing Cluster 22. This is a shared Processing Cluster 22.
3) It may have two or more Clusters 22 each dedicated to a single bank, so its user and merchant records for each Bank reside in a Cluster 22 dedicated to that bank. This is a one-to-one dedicated Processing Cluster 22;
4) It may have a combination of Dedicated and Shared Processing Clusters 22.

For each case where the Processor has more than one Cluster 22, the Clusters 22 are connected to each other via network 20. So, every Processing Cluster 22 can contact any other Processing Cluster 22. This allows the Processor to still get the benefits of account co-location with minimal overhead.

For example, with a one-to-one dedicated Cluster 22, when a user (user 1, on Cluster 1) sends $50 to a second user (user 2, on Cluster 2) the Processor does the following: Makes a database entry on Cluster 1, reducing the user's balance by $50, and then makes a call to Cluster 2, requesting a credit be applied to user 2. The transaction is still completed in real-time. Since both Clusters 22 belong to the Processor there are no intermediaries, and the connection between the Clusters 22 can be over the internet 20 which is low cost. The same model applies to many-to-one Dedicated Clusters.

For payment transactions, the merchant, on receiving the PIN 34, calls a phone number-to-Cluster Name service to determine the address of the Cluster 22 where the user's phone number record resides. It then calls that Cluster 22. Merchant transactions are always directed to the Processing Cluster 22 that hold that user's records. The Processor then does its updates to the PIN Table for that Cluster 22. At intervals, the Processor goes through its PIN Table and writes the transactions of each merchant into a merchant table. If that merchant account is not on that Cluster 22, the Processor uses the phone number-to-Cluster Name Service to identify the “home” Cluster of the merchant and uploads the merchant's temporary transaction table to it. On that Cluster 22, the Processor will append any temporary tables it receives via an upload to the local temporary table it has for that merchant. The resulting table shows all the transactions performed with that merchant by different users who have their accounts in different Clusters 22.

At intervals, the merchant uploads his file of approved transactions to his “home” Processing Cluster 22, i.e., the Cluster 22 that has the merchant's records, in order to get payment for transactions completed. The Processor then validates the loaded file by doing a SQL inner join of the loaded file with the merchant's temporary table; the inner join is on the Approval Number, item price, phone number 18 and PIN 34 with a group SUM on the item prices. This outputs a total amount from which the Processor subtracts its fees and then credits the merchant's database account (i.e., the merchants account on the database ledger). It also writes the output of the join into the merchant's history, so the merchant can view individual transactions.

### Example Embodiments

Applications for IOT and Intelligent Devices—This disclosure of system 10 and method 100 for processing micropayments can be used on any device 12 that has a unique identifier, a network connection, a CPU, and storage—enough to hold a tiny client app 30. This means that very small, low-power devices, like IOT devices, or larger “intelligent” devices, can make or receive micropayments. So, an IOT device, can provide a service on receiving a micropayment, and a device like Amazon Alexa®, can search and make a micropayment purchase of a video or audio book. Machines in a production environment could pay each other for maintenance services, materials or energy supply.

Payment by QR Code—Wherever the user needs to enter merchant or item data, he can scan QR code instead and then send the data with his phone number 18 and PIN 34 to the processor. After validating the phone number 18 and PIN 34 and price (i.e., confirm the price is encoded in the PIN 34), the Processor generates an Approval Number with an item price, and the user's phone number 18 and sends it to the merchant. The merchant may send the purchased item directly to the user's phone if it is content or deliver the service requested directly e.g., open a door, turn on a light, play some music. In this embodiment, the purchase is initiated and transmitted by the user using his own data plan, so cost is minimized. The Processor can be a process dedicated to just that merchant, where merchant is any process that receives payment and delivers a service.

Person to Person Payments—Users can benefit from mobile micropayments which is much faster than cash for offline transactions, and also much more secure, as users typically use a password or fingerprint to unlock their phones to make payment. Because a person-to-person mobile payment in this disclosure is a ledger entry, it is real time, and the mobile money transfer is immediately available to the recipient.

PIN without Amount—Instead of requiring the user to enter the transaction amount which is mixed with the OTPIN 36 to generate the PIN 34, the user can simply submit the OTPIN 36 as the PIN 34 along with the phone number 18 for item prices that exceed a threshold e.g., amounts over $2. The merchant then calls the Processor with the Phone Number 18, PIN 34, item price, item ID, Merchant ID and transaction ID. The serverless function, on receiving an item price above $2 (or some other cut-off amount), determines it is not encoded in the PIN 34 and then passes the transaction to a process which sends a message to the user with the item price, item ID and selling merchant. The user can then confirm that they are in fact paying that amount to that merchant. Once the Processor receives this confirmation, it updates its PIN Table with the item price, item ID, Approval Number, Merchant ID, Transaction ID and date. It then sends the Approval number to the Serverless Function who sends it to the merchant who can then release the good sold.

In this embodiment, the mobile app 30 still calls the Processor with the phone number 18 and PIN 34, but no item price. The Processor updates its PIN Table with both, but does not deduct any amount from the user's account. So, the PIN 34 is not funded. However, on receiving a merchant's request, the Processor contacts the user, through his app 30 on the user's mobile device 12 to confirm the payment before it can grant approval to the merchant. So, approval is granted only after the user confirms he made the payment. It also requires the user to be in possession of his mobile device 12 in order to authorize payment which prevents fraud. However, processing takes longer and is appropriate for larger sized transactions.

Phone Number-to-Cluster Resolution usage—The Phone Number-to-Cluster Name service need not be global but can have only local phone numbers within a given system or network. So, it can be used to spit Processing Clusters 22 within a network or system by updating only phone numbers within that network or system.

A phone number to processing cluster name service may be a method to resolve a phone number to the name of the Processing Cluster 22 holding that phone record. The name returned is a Fully Qualified Domain Name (FQDN) or IP Address. It is like Domain Name Service (DNS) with Name Servers arranged in a hierarchy. Global Authoritative Cluster Name Servers (GACNS)—have the FQDNs of each Country Server. Country Cluster Name Servers (CCNS)—have the Addresses of the servers in that country which have the mapping: “Phone number-to-Processing Cluster Address”. CCNS will direct a query to the appropriate Intra-Country Name Server, retrieve its response, and pass it up to the caller. Intra-Country Name Servers (ICNS)—Name servers that have the actual phone number to Cluster Name mappings. Each ICNS handles a specific block of phone numbers, for example, all phones beginning with a particular area code. A Processing Cluster 22 may have any mix of phone numbers 18; the GACNS, CCNS, or ICCNS when called with a phone number returns the Cluster FQDN or IP of the Processing Cluster where that phone record resides. Root, Country, and Intra-Country Servers may be duplicated for redundancy.

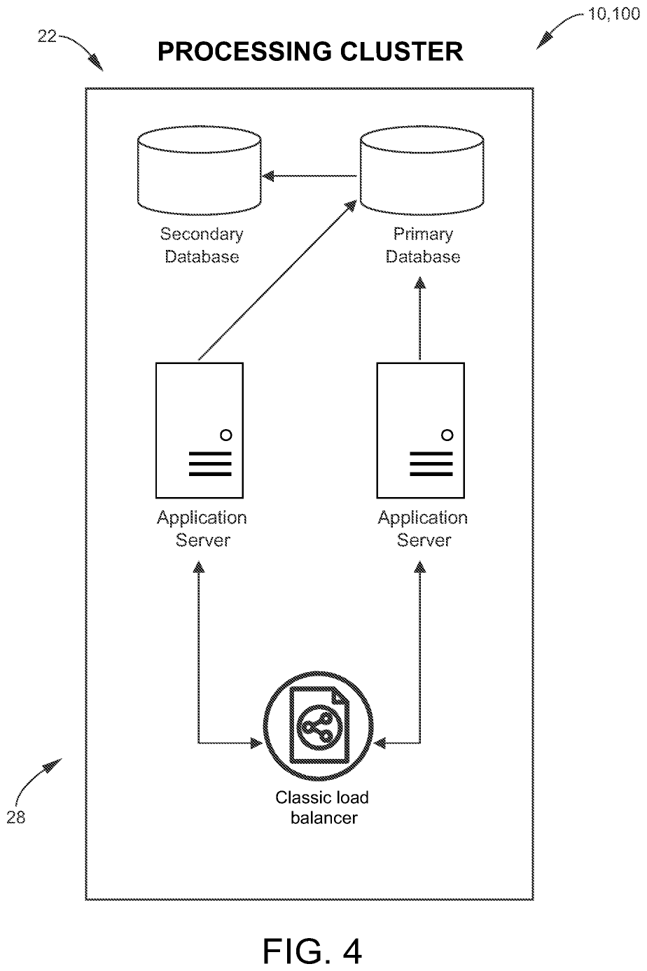

Referring now specifically to the embodiments shown in FIG. 4, a sample processing cluster 22 is shown for use with system 10 and/or method 100 of processing micropayments. As shown, each Processing Cluster 22 has a Load Balancer that distributes requests to its Application Servers. The address of the Processing Cluster 22 is the Address of the Load Balancer. Application Servers are behind the Load Balancer which distributes requests to them. The Application Servers contain all the logic for performing transactions including matching its transaction records with that of the bank where funds for each record reside. Application servers read and write from a backend database that has a primary and secondary node for High Availability. As examples, the Application Servers may generate messages (email or SMS) to Users, initiating communications with a bank where the User's funds reside, querying a Name Server, updating accounts on a Name Server, etc. The database holds specific customer records which have phone numbers as a primary key. The database also contains the transactions and fund balances of each record, which may include transaction records, fund balances, User data, account status, etc. A phone number to Processing Cluster Address Resolution Scheme enables authorized processes to retrieve, update, delete or create a record for the Processing Cluster where any phone record is held, like via the Name Server which maps account (i.e., phone number) to Processing Cluster.

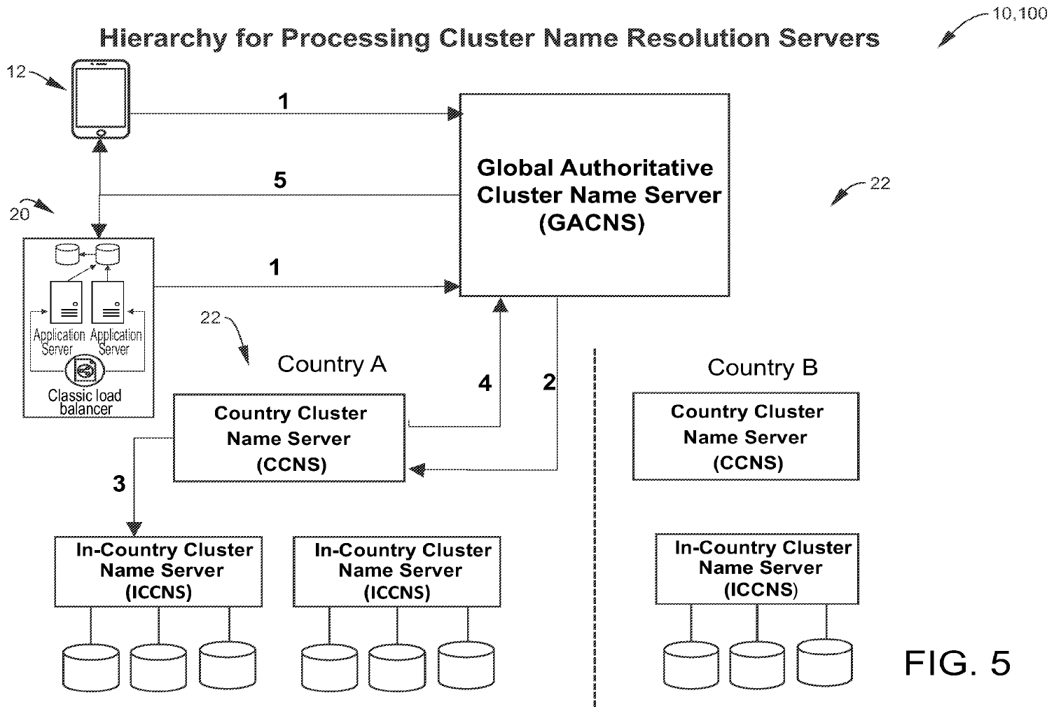

Referring now specifically to the embodiments shown in FIG. 5, a sample hierarchy for processing cluster name resolution servers is shown for use with system 10 and/or method 100 of processing micropayments. As shown, App 30 or Processing Cluster 22 calls GACNS with phone number 18 to find the Processing Cluster 22 that holds that phone record or to determine if a record for that phone number exists. GACNS from the country code of the phone number identifies the CCNS for that country and forwards the request to it. The CCNS checks its records to find the ICCNS server that holds the records for that phone number 18. (ICCNS servers are assigned phone records using a scheme, for example a server may hold only the records for a specific area code). CCNS then calls that ICCNS server. The ICCNS server may return the Fully Qualified Domain Name (FQDN) and IP Address of the Processing Cluster 22 (i.e., its address) or may query another ICCNS server below it. Query response is recursive. ICCNS retrieves the Processing Cluster Address and returns it to CCNS, who returns it to GACNS or the caller. A caller may call CCNS or ICCNS directly and receive a full response (with Token). GACNS generates a Token to be used to call that Processing Cluster 22 and returns both Token and Processing Cluster Address to the caller. The caller can then call that Processing Cluster 22. The same steps may be used to change the Cluster address of an existing phone record or to create a new phone record.

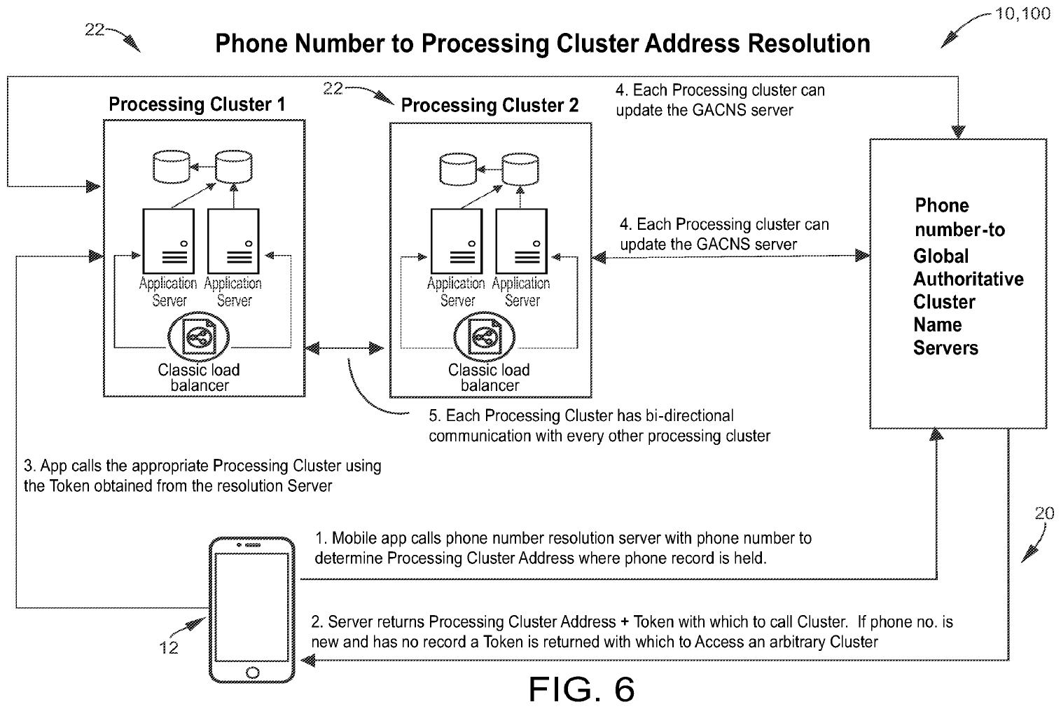

Referring now specifically to the embodiments shown in FIG. 6, a sample phone number to processing cluster address resolution is shown for use with system 10 and/or method 100 of processing micropayments. As shown, each Record in a Processing Cluster 22 is associated with a phone number 18. Each Record is stored in a specific Processing Cluster 22, with a unique address, and can perform transactions on all the records it holds. The ICCNS server can be queried to download all the records for a particular Processing cluster 22. All Names Servers Return a Token with a response with which to access the Processing Cluster address returned. This is a key difference from DNS.

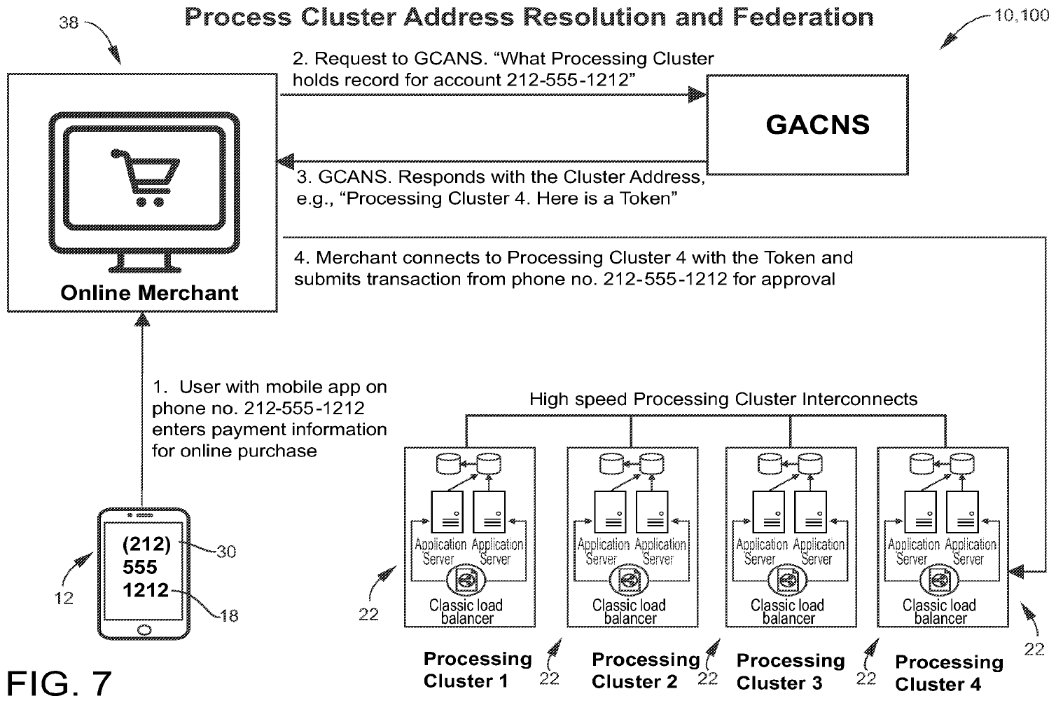

Referring now specifically to the embodiments shown in FIG. 7, a process cluster address resolution and federation is shown for use with system 10 and/or method 100 of processing micropayments. As shown, each Processing Cluster 22 holds a unique set of phone numbers 18 representing user accounts. This is database federation with a “Share Nothing” architecture. Transactions for any account are handled only by the particular Processing Cluster 22 that holds that account record in its database. Each database record is associated with a phone number 18. Each Processing Cluster 22 has a Fully Qualified Domain Name and one or more IP Addresses that are returned by the Global Cluster Address Name Server (GCANS).

A database scaling out and scaling in process can be used with system 10 and/or method 100 of processing micropayments. Each Processing Cluster 22 has a database which holds user records managed by the Cluster. Under load, the database can become a bottleneck, which will raise the cost and time of processing. So, a NEW Processing Cluster 22 is created, its database is populated with some of the very active records from the “mother” or Original database. All calls for the transferred records go to the NEW cluster 33. So for Scaling out: a) the ORIGINAL Processing Cluster spawns a NEW Processing Cluster 22, with database, application server, load balancer, new fully qualified domain name, and new IP address(es); b) it first copies the most active records to the database of the NEW Cluster 22 and synchronously replicates writes to those records to the database of the NEW Processing Cluster 22; c) it then updates the Address of the Processing Cluster 22 for those records by calling the GACNS, CCNS or ICCNS Name Server and changes their Cluster address to that of the NEW Processing Cluster 22; and d) it drops any connections that are writing to those records, and invalidates the Tokens for those callers. The callers are forced to query a name server to get a Token with which to reconnect to the Cluster 22. They will get then get New Processing Cluster address and a Token to connect to it. The disconnected Users and all subsequent callers who wish to access the transferred records connect to the New Processing Cluster 22. Rather than terminate the User connections to the active records in its database, the Original Cluster 22 can simply wait for the Token or the Time-to-Live (TTL) of the Cluster Name retrieved by the caller to expire. So, when the caller next queries a Name Server that that record, it will get the name of the NEW Processing Cluster 22.

Referring now specifically to the embodiments shown in FIG. 8, processing cluster database splitting, or scaling out, is shown for use with system 10 and/or method 100 of processing micropayments. As shown, automatic splitting of a Processing Cluster Database occurs in response to high load, captured in database metrics. Too many connections to a Processing Cluster 22 create high load on Cluster Database. The overactive Users or queries causing the high load are identified from database statistics and metrics. At a specified threshold, a NEW Processing Cluster 22 is spawned and the overactive Users, represented by their Phone no. 18 in the database records of the ORIGINAL cluster 22, are copied to the database of the NEW Cluster 22 and synced synchronously with the “Original” database. The ORIGINAL Processing Cluster 22 calls the Global Cluster Address Name Server (GCANS) and changes the Processing Cluster Address of the overactive User records, represented by their phone no. 18, to the NEW Processing Cluster Address. The ORIGINAL Processing Cluster 22 invalidates the Token of the overactive Users and drops their connections. The callers of the overactive Users must call GCANS to get a new Token with which to reconnect to their Cluster 22. GCANS returns the NEW Processing Cluster Address with a Token. The callers (User A & User B in the diagram), then connect with the Token to the NEW Processing Cluster 22 that holds their records. The steps can be reversed to make the two Clusters 22 one, if database load falls below a specified threshold.

Transacting when accounts are on different clusters 22 is a part of the disclosure for use with system 10 and/or method 100 of processing micropayments. User accounts can reside on different Processing Clusters 22 (i.e., the Cluster database). Transactions are still performed efficiently. The Clusters 22 are connected, preferable with a high-speed network 20 interconnect so there is reduction in network latency. Each Processing Cluster 22 handles messaging, database updates and processing of all its own records. Each Cluster 22 can immediately determine it holds a particular record and if not call a name server (GACNS, CCNS or ICCNS) to find the Processing Cluster 22 for that record. The communication between Clusters 22 is secure (encrypted).

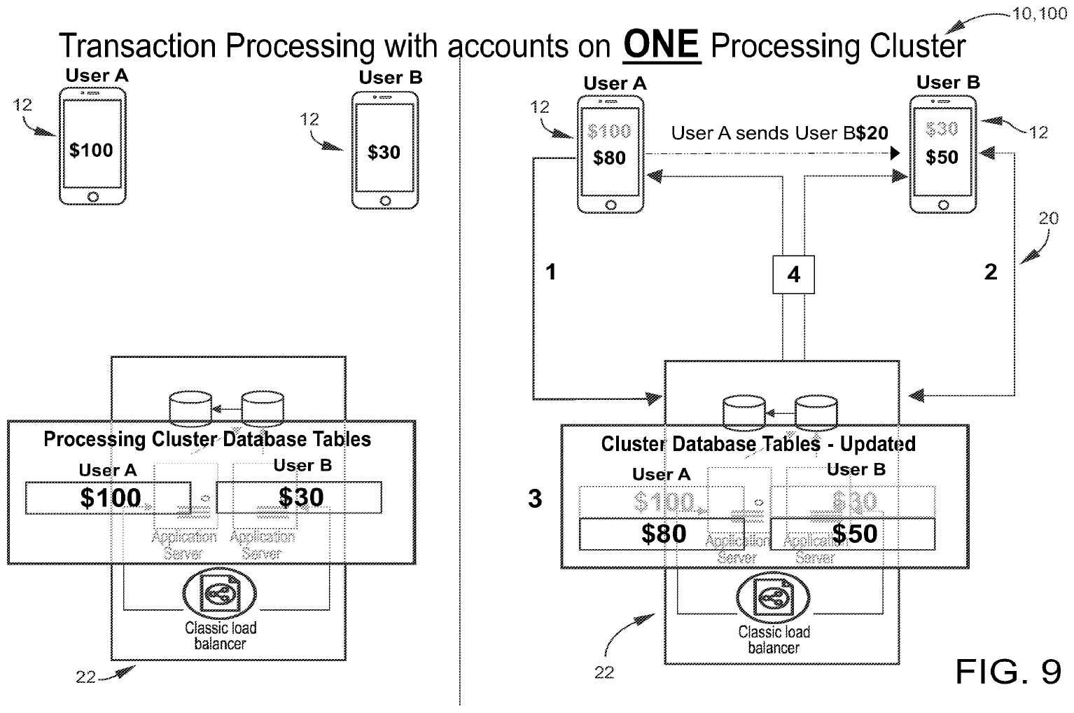

Referring now specifically the embodiments shown in FIG. 9, transaction processing with accounts on ONE processing cluster 22 is shown for use with system 10 and/or method 100 of processing micropayments. As shown, User A sends $20 to User B from his mobile app 30. Messages do not go directly from User A to User B. Instead, User A's app 30 calls the Processing Cluster 22 that holds his phone no. 18 (which is the primary key to his account) and then sends the request to that Cluster 22. The Processing Cluster 22 first confirms that it holds the records for User B. It then generates a message of the transfer to User B who accepts the transfer. (This step is skipped if acceptance is not required). Processing Cluster 22 updates User A and User B records in its database tables. It sends messages to both users to confirm their new account balances. Since the records of User A and User B are located on the same Processing Cluster 22, updating these records (i.e., accounts) entails NO NETWORK OVERHEAD, and the funds sent by User A are immediately available to User B.

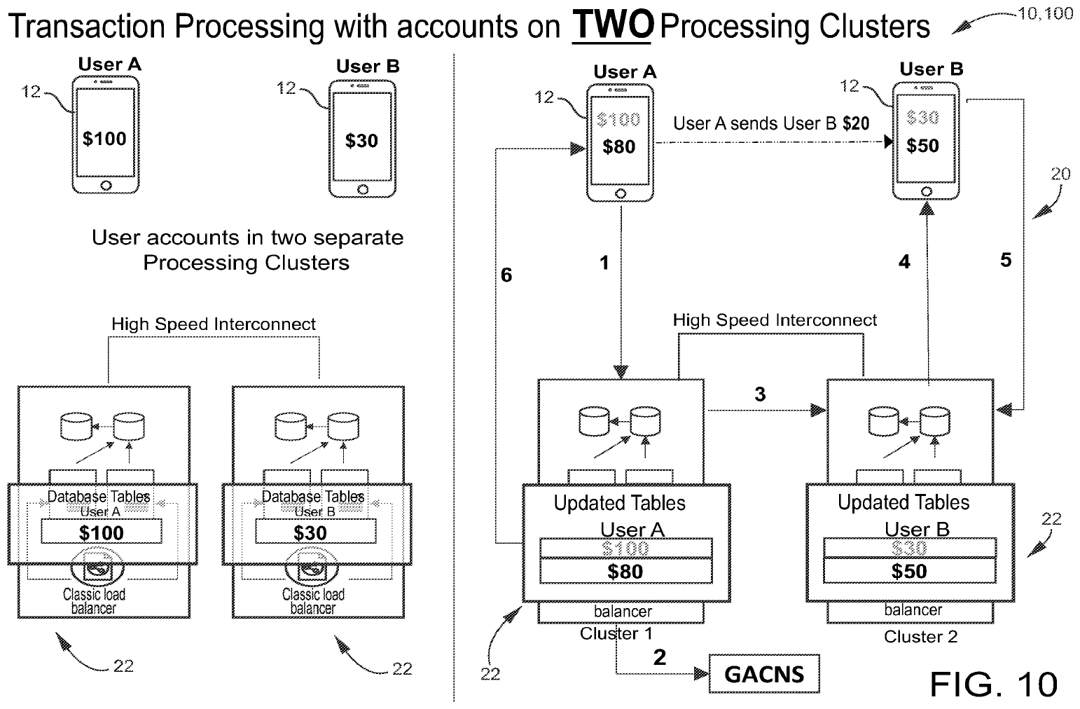

Referring now specifically to the embodiments shown in FIG. 10, transaction processing with accounts on TWO processing cluster 22 is shown for use with system 10 and/or method 100 of processing micropayments. As shown, User A sends $20 to User B from mobile app 30. User A's app 30 calls the Processing Cluster 22, Cluster-1, that holds his account. Cluster-1 sees it holds the records for User A but not User B. So, it calls GACNS (Name Server) and finds that another cluster 22, Cluster-2, holds User B's records. It debits User A for $20 and informs Cluster-2 of the transaction. Cluster-2 credits User B's account, in its local database, and informs User B. Each Cluster 22 is responsible for sending and receiving messages for its accounts. User B's mobile app 30 confirms receipt of the credit message and can use the funds immediately. Cluster-1 informs User A that the transaction is completed. Although the User accounts are in different clusters 22, the transaction is completed with a single network call (3) from Cluster-1 to Cluster-2.

Referring now specifically to the embodiments shown in FIG. 11, selecting an image from a block of images for authentication is shown for use with system 10 and/or method 100 of processing micropayments. As shown, rather than enter a password each time authentication is required, it is convenient to select an image from a block of images during sign up. Subsequently, the user just clicks or taps an image to authenticate. For example, a block of 35 images in 7×5 matrix is easy for the humans to pick out an image from but difficult for machines. Because the probability of a correct random guess is high, different schemes can be used to reduce this probability. First, the user can be required to select 2 or more images in sequence from a single block of images, or select a single image from each of several blocks of images. For example, a user can select an image from a block of 35 images; the selection opens up a new block of 35 images from which she is required to select a second image. Here, the probability of a correct guess drops to 0.08%, if she selects from 3 blocks of 35 images, the probability of a lucky guess drops even more and is achieved with just 3 mouse clicks or 3 taps of a finger. In addition, selecting an image can enlarge the selected image, and then require the user to select one or more objects from the enlarged image. After one image authentication failure, the user will be required to enter a password AND their image(s). This eliminates brute force attacks. After successful authentication with password and image, the user can once again authenticate with his image alone; he will always need to select a password and image(s) after the first failure of image authentication.

Image authentication may follow the same form as password authentication: Each image is associated with a hexadecimal number (easily imagined as a number written behind a picture postcard). The first time the user chooses an image, a salt is added to the number for that image, passed through a hashing function (e.g., SHA3-256), and the output hash is stored. Subsequently, when a user selects an image from the block of images, the same salt is added, the result is hashed, and the output is compared with the stored hash. If they match, the correct image was selected. If both salt and hash output are stored locally, authentication is fast, but given access to the storage device, the correct image can be found by testing the salt with each image. For devices where stored data can be easily accessed, system 10 and/or method 100 may do either of the following: a) the output hash is stored remotely, and hash matching performed remotely (the remote server determines the number of failures after which it will require BOTH a password and image authentication); and b) the initial image selected is sent to a server. Subsequent image selections are also sent to the server and matched with a machine learning algorithm. The server may also require BOTH password and image authentication after a specified number of image authentication failures.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A system for processing payments comprising:
a user device of a user, the user device includes a processor, memory, and a phone number;
a network, the user device is configured to communicate over the network;
a payment processor with a processor and memory in communication with the user device over the network;
a client application installed on the user device of the user, the client application is configured to process the payments from the user through the payment processor over the network, wherein the client application on the user device is configured to:
create a mobile account of the user with the payment processor, where the mobile account of the user device is linked with the phone number of the user device;
process a payment from the mobile account of the user by utilizing the phone number of the user device for authenticating the payment; and
wherein the payment processed from the mobile account of the user can only be initiated from the user device of the user as the phone number of the user device is linked to the mobile account of the user and is used to authenticate the payment.

2. The system for processing payments of claim 1, wherein the client application is configured to create the mobile account of the user with the payment processor on a processing cluster by signing up the user with the payment processor with required security credentials of the user and the phone number of the user device of the user and saving it with the payment processor on the processing cluster, where the payment processor saves the required security credentials of the user to the mobile account of the user and links the phone number of the user device to the mobile account of the user on the processing cluster.

3. The system for processing payments of claim 1, wherein the client application is configured to process the payments from the mobile account of the user and always display a balance of funds of the user in real time on the user device of the user.

4. The system for processing payments of claim 1, wherein the client application is configured to process the payments from the mobile account of the user by generating a PIN on the user device of the user.

5. The system for processing payments of claim 4, wherein the PIN is generated by the user entering a payment amount and encoding the payment amount with an expiring OTPIN;
wherein, when the PIN is generated, the payment amount is deducted from funds of the mobile account and the PIN is sent to the payment processor before displaying it to the user on the client application; and
wherein the expiring OTPIN is encoded using a key downloaded from the payment processor over the network which is derived from the phone number of the user device of the user and is therefore unique to the user device of the user.

6. The system for processing payments of claim 5, wherein, when the user provides the PIN generated by the client application and the phone number of the user device of the user to a merchant, and the merchant sends the PIN and the phone number to the payment processor over the network along with an item price, the payment processor is configured to decode the PIN into the OTPIN and a decoded payment amount for the payment processor, and the payment processor is configured to authenticate the following:
the decode payment amount equals the payment amount;
the OTPIN has not expired;
the PIN was generated on the user device of the user that wrote the PIN via the phone number of the user device; and
funds of the payment amount were deducted from the mobile account of the user.

7. The system for processing payments of claim 6, wherein, when the merchant submits a file of an approved transaction via an API call to the payment processor, the payment processor is configured to identify if the approved transaction is valid and credit the merchant the payment amount minus any transaction processing fees.

8. The system for processing payments of claim 1, wherein, the payment processor includes a bank, the bank is configured to hold funds of the user for use in the system, the bank is also configured to move funds of the user in and out of the system over the network through the client application by either a funds transfer from a different bank account, using common methods including ACH, RTP, or Fedwire, by depositing a check, by charging a credit or debit card, or by paying cash to an agent of the payment processor.

9. The system for processing payments of claim 1, wherein the user device is a mobile phone assigned with the phone number.

10. The system for processing payments of claim 1, wherein:
the payments processed from the mobile account of the user are micropayments;
PIN validation by the payment processor takes less than 400 milliseconds;
the system for processing payments is configured to process ten million micropayment transactions in under 10 seconds; and
the payment processor authenticates the payment by the user without requiring entry of personal information of the user.

11. A system for processing payments comprising:
a user device of a user, the user device includes a processor, memory, and a phone number;
a network, the user device is configured to communicate over the network;
a processing cluster controlled by a payment processor, the processing cluster includes a processor and memory in communication with the user device over the network;
a merchant in communication with the processing cluster over the network;
a client application installed on the user device of the user, the client application is configured to process the payments from the user to the merchant through the payment processor over the network, wherein the client application is configured to:
create a mobile account of the user with the payment processor on the processing cluster, where the mobile account of the user is linked with the phone number of the user device of the user;
process a payment to the merchant from the mobile account of the user by utilizing the phone number of the user device of the user for authenticating the payment;
wherein the payments processed from the mobile account of the user can only be initiated from the user device of the user because the phone number of the user device is linked to the mobile account of the user and is used to authenticate the payment;
wherein the client application is configured to create the mobile account of the user with the payment processor on the processing cluster by signing up the user with the payment processor with required security credentials of the user and the phone number of the user device of the user and saving it on the processing cluster, where the payment processor saves the required security credentials of the user to the mobile account of the user and links the phone number of the user device to the mobile account of the user on the processing cluster;
wherein the client application is configured to process the payments to the merchant from the mobile account of the user and always display a balance of funds of the user in real time on the user device of the user;
wherein the client application is configured to process the payments to the merchant from the mobile account of the user by generating a PIN on the user device of the user;
wherein, the PIN is generated by the user entering a payment amount and encoding the payment amount with an expiring OTPIN;
wherein, when the PIN is generated, the payment amount is deducted from the funds of the mobile account and the PIN is sent to the payment processor before displaying it to the user on the client application;
wherein the expiring OTPIN is encoded using a key downloaded from the processing cluster of the payment processor over the network which is derived from the phone number of the user device of the user and is therefore unique to the user device of the user;
wherein, when the user provides the PIN generated by the client application and the phone number of the user device of the user to the merchant, and the merchant sends the PIN and the phone number to the payment processor over the network along with an item price, the processing cluster is configured to decode the PIN into the OTPIN and a decoded payment amount for the payment processor, and the payment processor is configured to authenticate the following:
the decoded payment amount is equal to the payment amount;
the OTPIN has not expired;
the PIN was generated on the user device of the user that wrote the PIN via the phone number of the device;
the funds of the payment amount were deducted from the mobile account of the user;
wherein, when the merchant submits a file of an approved transaction via an API call to the payment processor, the payment processor is configured to identify if the approved transaction is valid and credit the merchant the payment amount minus any transaction processing fees;
wherein, the payment processor includes a bank, the bank is configured to hold the funds of the user and funds of the merchant for use in the system, the bank is also configured to move the funds of the user and the merchant in and out of the system over the network through the client application by either a funds transfer from a different bank account, using common methods including ACH, RTP, or Fedwire, by depositing a check, by charging a credit or debit card, or by paying cash to an agent of the payment processor;
wherein, the user device is a mobile phone assigned with the phone number;
wherein, the payments processed to the merchant from the mobile account of the user are micropayments;
wherein, PIN validation by the processing cluster takes less than 400 milliseconds;
wherein, the system for processing payments is configured to process ten million micropayment transactions in under 10 seconds; and
wherein, the payment processor authenticates the payment by the user without requiring entry of personal information of the user.

12. A method for processing payments comprising:
installing a client application on a user device of a user, the user device including a processor, a memory, and a phone number;
signing up the user with a payment processor through the client application on the user device including providing all required security credentials;
submitting the phone number of the user device to the payment processor through the client application on the user device;
assigning a mobile account to the user and saving the required security credentials provided of the user along with the phone number associated with the user device of the user in the assigned mobile account of the payment processor;
linking the user device of the user to the assigned mobile account of the user via the phone number of the user device, wherein the user can process the payments only from the linked user device via the phone number of the user device;
adding funds to the assigned mobile account of the user by transferring money to the assigned mobile account; and
processing a payment from the user via the client application on the user device of the user by authenticating the payment via the phone number of the user device of the user.

13. The method for processing payments of claim 12, wherein the client application is configured to create the mobile account of the user with the payment processor on a processing cluster by signing up the user with the payment processor with the required security credentials of the user and the phone number of the user device of the user and saving it on the processing cluster, where the payment processor saves the required security credentials of the user to the mobile account of the user and links the phone number of the user device to the mobile account of the user on the processing cluster.

14. The method for processing payments of claim 12, wherein the client application is configured to process the payments from the mobile account of the user and includes always displaying a balance of the funds of the user in real time on the user device of the user.

15. The method for processing payments of claim 12, wherein the client application is configured to process the payments from the mobile account of the user by generating a PIN on the user device of the user.

16. The method for processing payment of claim 15, wherein the PIN is generated by:
the user entering a payment amount and encoding the payment amount with an expiring OTPIN; and
wherein, when the PIN is generated, the payment amount is deducted from the funds of the mobile account and the PIN is sent to the payment processor before displaying it to the user on the client application;
wherein the expiring OTPIN is encoded using a key downloaded from the payment processor over a network which is derived from the phone number of the user device of the user and is therefore unique to the user device of the user.

17. The method for processing payments of claim 16, wherein when the user provides the PIN generated by the client application and the phone number of the user device of the user to a merchant, and the merchant sends the PIN and the phone number provided to the payment processor over the network along with an item price, the payment processor decoding the PIN into the OTPIN and a decoded payment amount for the payment processor, and the payment processor authenticating the following:
the decoded payment amount equals the payment amount;
the OTPIN has not expired;
the PIN was generated on the user device of the user that wrote the PIN; and
the funds of the payment amount were deducted from the mobile account of the user.

18. The method for processing payments of claim 17, wherein, when the merchant submits a file of an approved transaction via an API call to the payment processor, the payment processor identifying if the approved transaction is valid and crediting the merchant the payment amount minus any transaction processing fees.

19. The method for processing payments of claim 12, wherein, the payment processor includes a bank, the bank holding the funds of the user for use, the bank also moving the funds of the user in and out of the mobile account over a network through the client application.

20. The method for processing payments of claim 12, wherein:
the user device is a mobile phone assigned with the phone number;
the payments processed from the mobile account of the user are micropayments;
wherein PIN validation by the payment processor takes less than 400 milliseconds;
wherein the method for processing payments is configured to process ten million micropayment transactions in under 10 seconds; and
wherein, the payment processor authenticates the payment by the user without requiring entry of personal information of the user.
